(19) United States
(12) Patent Application Publication
(10) Pub. No.: US 2013/0129879 A1
(43) Pub. Date: May 23, 2013

(54) NEUTRAL BEVERAGE AND OTHER COMPOSITIONS AND PROCESS FOR MAKING SAME

(71) Applicants: JENNIFER WHITE, ST. LOUIS, MO (US); DAVID WELSBY, ST. LOUIS, MO (US); CHARLES KOLAR, ST. LOUIS, MO (US)

(72) Inventors: JENNIFER WHITE, ST. LOUIS, MO (US); DAVID WELSBY, ST. LOUIS, MO (US); CHARLES KOLAR, ST. LOUIS, MO (US)

(21) Appl. No.: 13/679,840

(22) Filed: Nov. 16, 2012

Related U.S. Application Data
(60) Provisional application No. 61/561,591, filed on Nov. 18, 2011.

(51) Int. Cl. A23C 11/10; A23J 3/16

(52) U.S. Cl. CPC A23C 11/103; A23J 3/16
USPC 426/271; 426/656; 426/590; 426/598

(57) ABSTRACT

The present invention relates to the use of at least one acid soluble vegetable protein in a neutral beverage application. The neutral beverage application includes a soymilk. The current application produces a soymilk having a bland taste and a whiteness index close to cow's milk.

### CROSS REFERENCE TO RELATED APPLICATIONS

This application claims priority from U.S. Provisional Application Ser. No. 61/561,591 filed on Nov. 18, 2011.

### FIELD OF THE INVENTION

The present invention generally relates to an acid soluble vegetable protein composition that can be used in neutral beverage applications. More specifically, the invention is drawn to the use of the acid soluble vegetable protein composition in vegetable milk applications so that the vegetable milk approaches the whiteness of cow's milk and does not have the characteristic “soy legume” flavour attributes.

### BACKGROUND OF THE INVENTION

Soymilks, whether made from whole bean extracts by traditional methods, or from concentrated or isolated soy proteins, cannot match the whiteness and bland flavour of cow's milk, thus reducing their appeal to consumers. Cow's milk is white for two main reasons. Firstly, casein in milk is formed into large micelles that are large enough to diffract light and scatter it. Casein micelles are of the order of 130-150 nM in diameter, which is of the same order of magnitude as the wavelength of light. The light scattered by the casein micelles is perceived as milky to the human eye, and so skim milk looks white. In whole milk and semi-skimmed milk, milk fat is also present. The fat is in the form of globules, each stabilised by the milk-fat globule membrane. Milk-fat globules have an approximate mean diameter of about one micrometre in homogenised milk and form a colloidal suspension that also scatters light and adds to the milkiness produced by the casein micelles.

Soymilk made from whole soybeans does not contain the protein in the form of micelles. In the soybean seed, protein is present in the form of discreet protein bodies that range in size from 2-20 μM. On exposure to water at neutral pH, these swell and double in size, eventually bursting and releasing numerous small particles of about 0.5 μM in diameter. The fat in soymilk extracted from whole milk is in the form of oil bodies and are relatively stable. They are surrounded by proteins known as oleosins that act as emulsifiers. Soybean oil bodies range in size from about 0.1 to 1.0 μM and are very resistant to processing. Based on the nature and sizes of the protein particles and oil bodies present in unflavoured soymilks, light scattering does not produce the impression of whiteness to the human eye, the best such products available on the market appearing tan to off white.

None of these arguments applies to soymilks manufactured from soy protein extracts, with refined oils and carbohydrates added back to meet a desired nutritional profile. None of these products has protein bodies, although the emulsion produced by high pressure homogenisation does contain fat globules in the desired range to scatter light. Nevertheless, coloured compounds associated with these proteins result in the production of a soymilk with a whiteness index lower than milk, and in the same general range as those found in whole bean extracts.

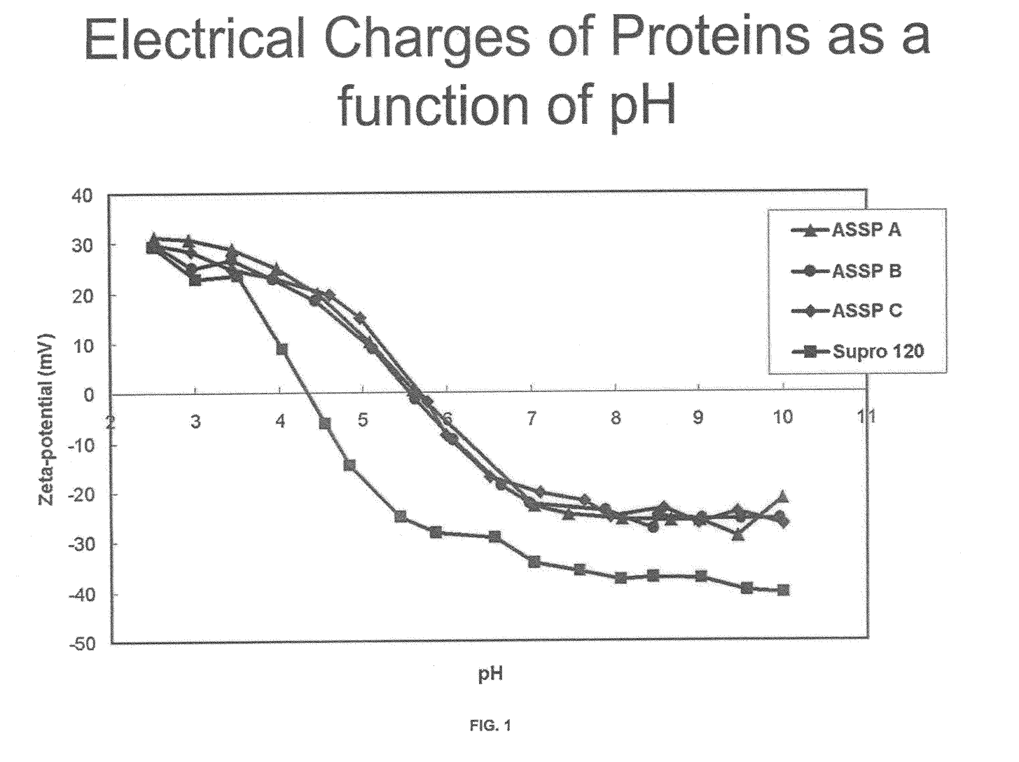

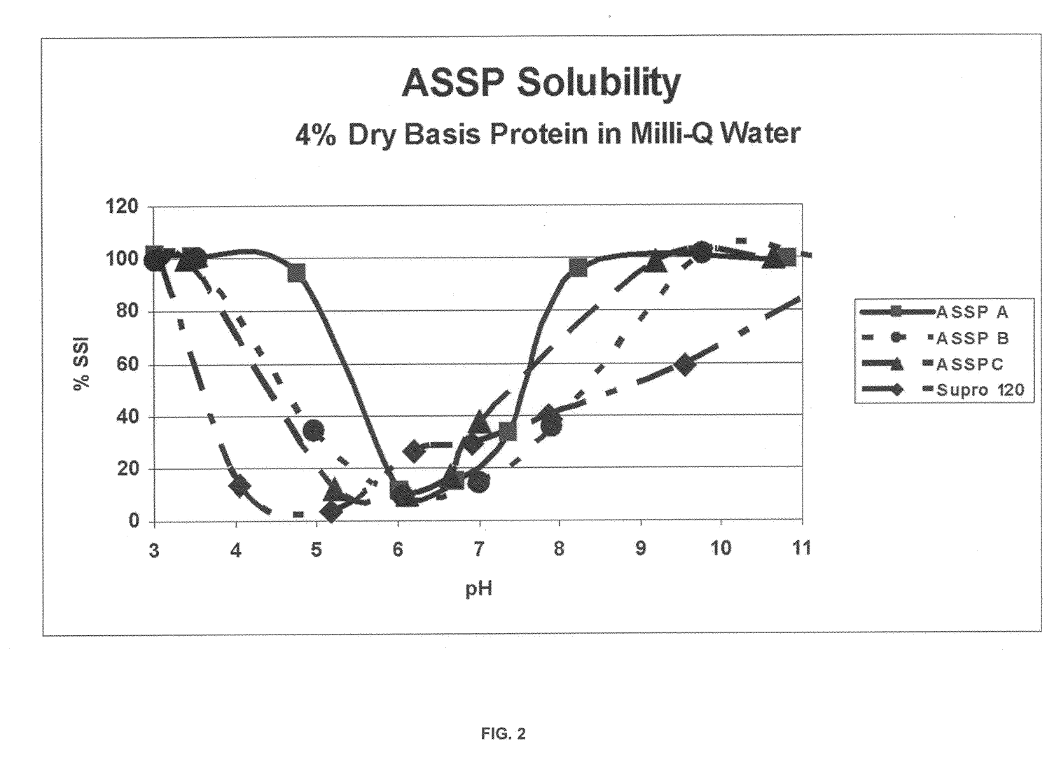

U.S. Patent Application 2010/0215830 A1 dated Aug. 26, 2010, teaches that soy proteins extracted from defatted soy flour or defatted soy flakes using aqueous solutions of calcium salts show remarkable pH solubility profiles. Conventional isolated soy proteins are soluble at neutral pH and almost completely insoluble at their isoelectric point, about pH 4.5 (FIG. 1). Calcium extracted protein, on the other hand, is almost completely insoluble at pH 7.0, (FIG. 2) but exhibits high solubility and complete translucency in solutions of pH 3.0-3.5. at up to 8% protein, thus rendering its potential application in acid beverages obvious. It has a very neutral flavour with no soy notes.

### SUMMARY OF THE INVENTION

The present invention is to a neutral beverage composition comprising a neutralized acid soluble protein isolate. In addition to the acid soluble protein isolate, other vegetable proteins may be used. Vegetable proteins include but are not limited to oilseed proteins, pea proteins, other legumes and combinations thereof. Oilseed proteins include but are not limited to soy protein and canola protein.

The present invention is further drawn to a method of making the neutralized acid soluble vegetable protein by treating the acid soluble vegetable protein with a chelating agent at the native pH of the acid soluble vegetable protein. Thus, at an acidic pH between about 3.0 to about 3.5 prior to neutralizing the acid soluble vegetable protein.

The present invention is also directed to a method of making the neutral beverage composition and other neutral applications.

### REFERENCE TO COLOR DRAWINGS

The application contains at least one photograph executed in color. Copies of this patent application publication with color photographs will be provided by the Office upon request and payment of the necessary fee.

### BRIEF DESCRIPTION OF DRAWINGS

FIG. 1 is a graph showing the solubility curve for the neutralized acid soluble soy protein composition.

FIG. 2 is a graph showing the electrical charges of proteins as a function of pH.

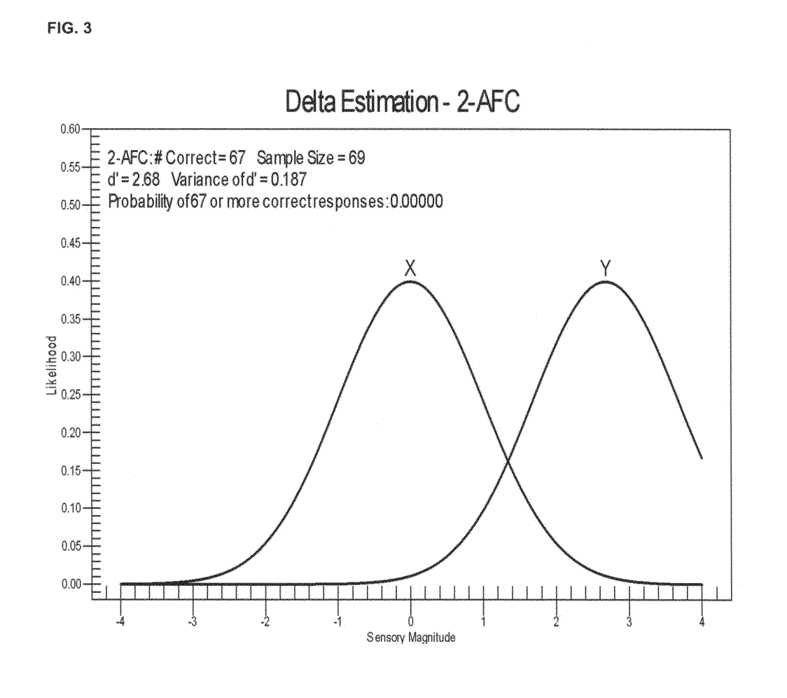

FIG. 3 is a graph showing responses as to which is the “whiter” sample using a computerized data collection system with Compuserve Five® version 5.2 software.

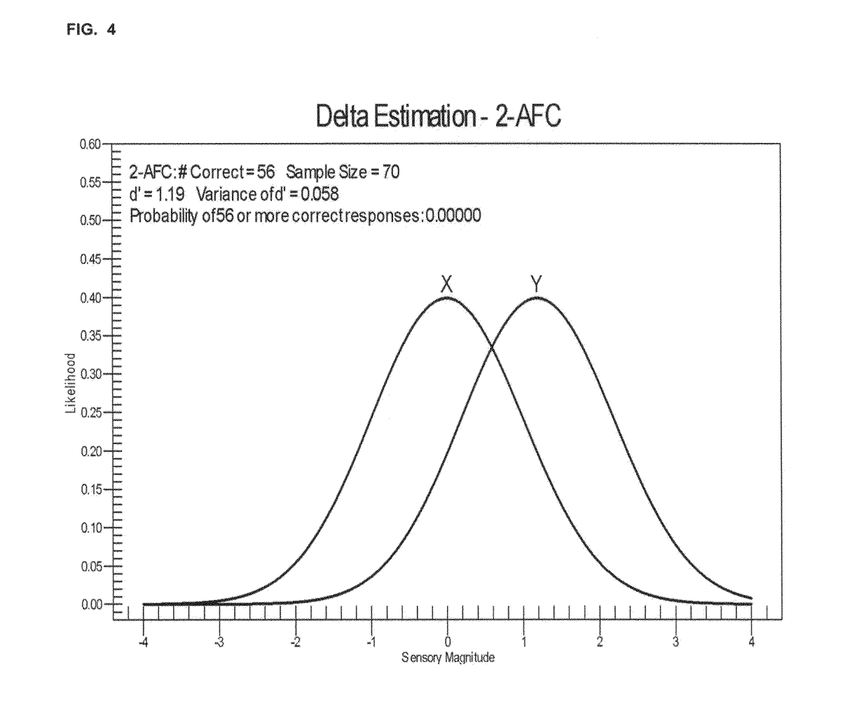

FIG. 4 is a graph showing responses as to which sample has “more soy flavor” using a computerized data collection system with Compuserve Five® version 5.2 software.

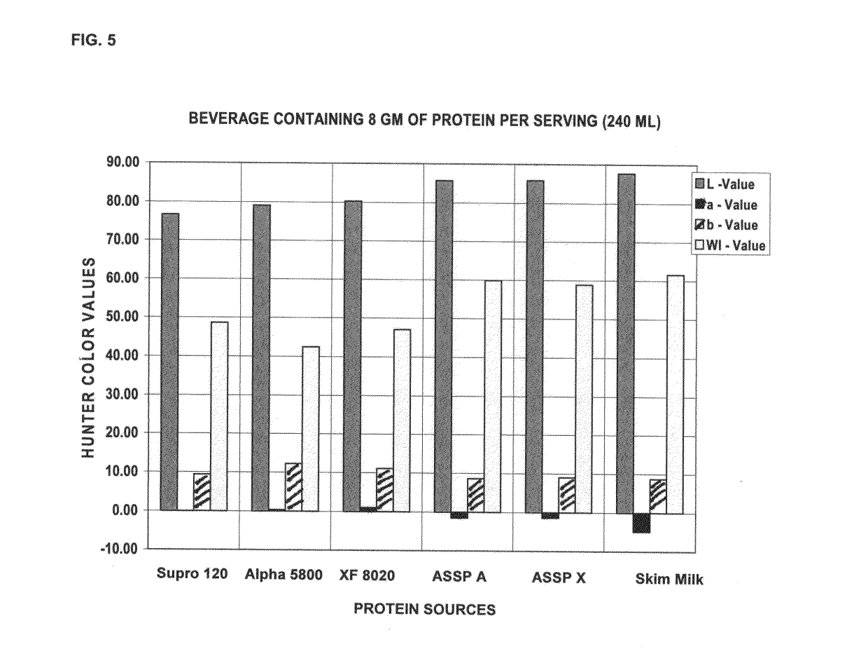

FIG. 5 is a bar graph showing color data plotted for soymilks (Supro®120, Alpha®5800, Supro®XF8020, ASSP A, and ASSP X) and skim milk (cow's milk) as measured with the Hunter Color Difference Meter.

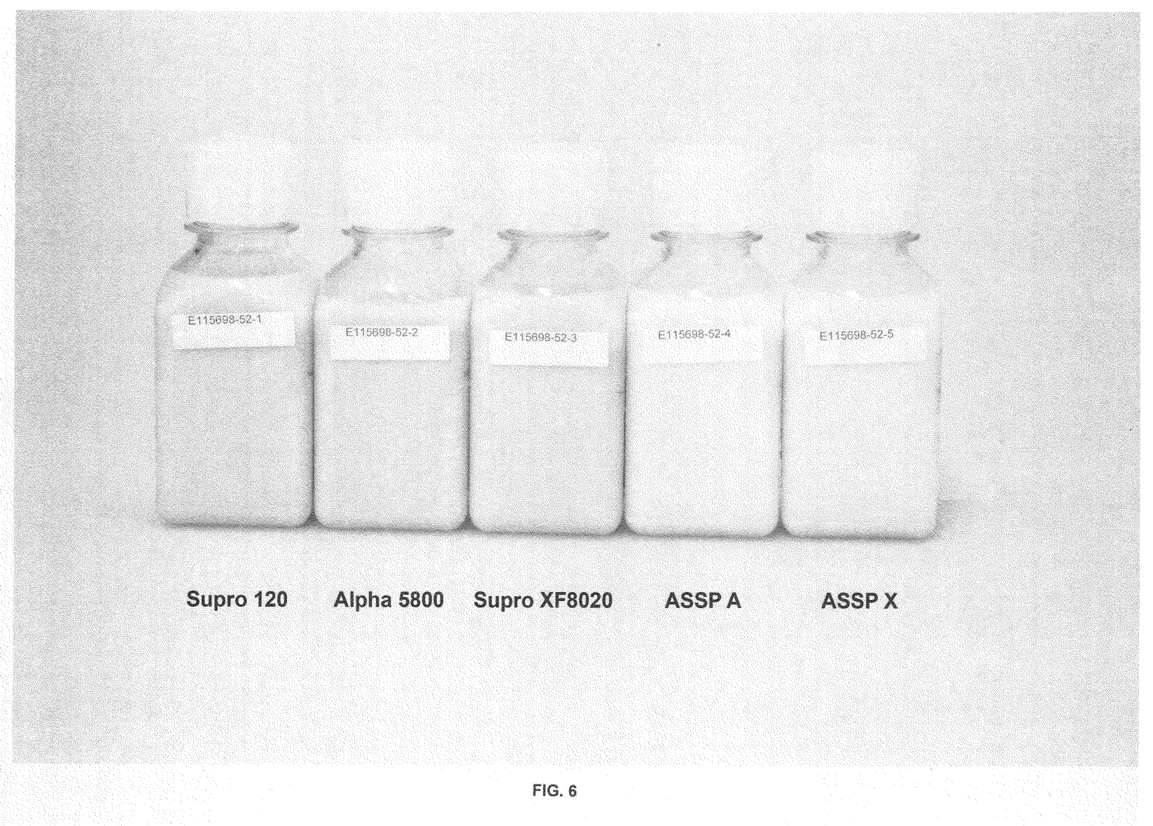

FIG. 6 is a photograph showing the results of the soymilk made in Example 2.

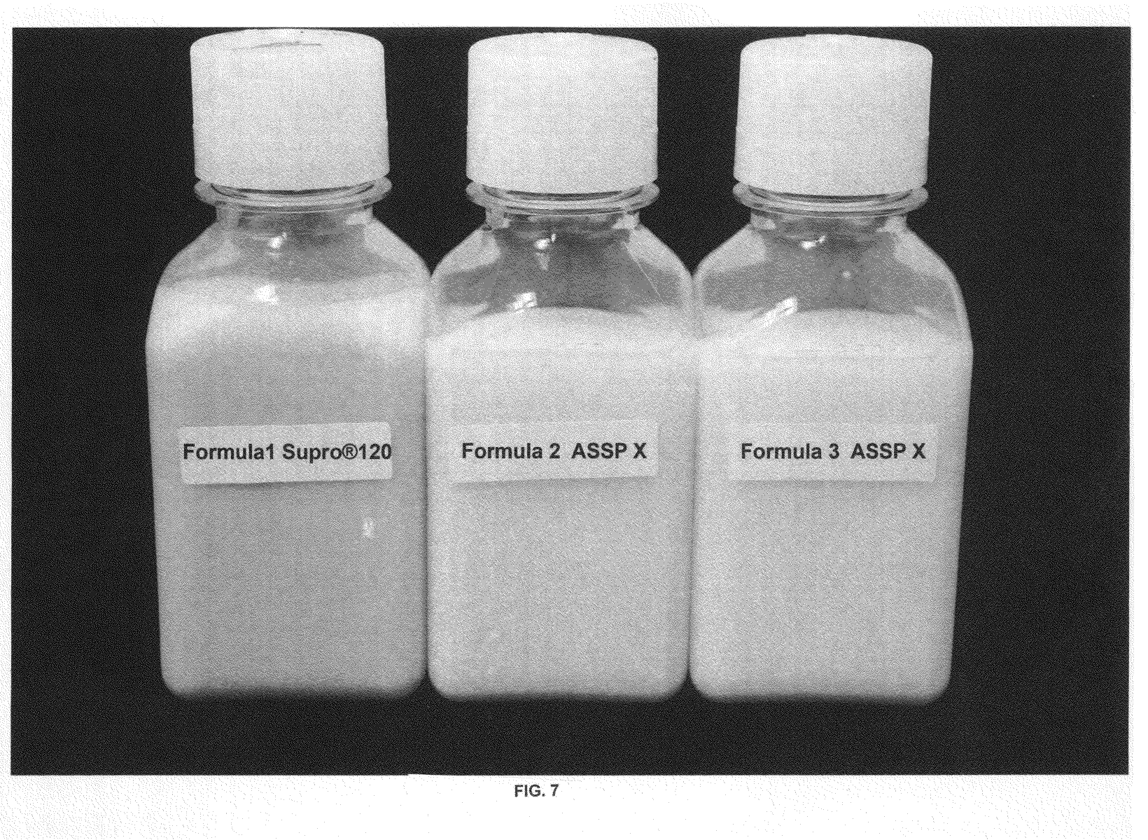

FIG. 7 is a photograph showing the results of the soymilk made in Example 3.

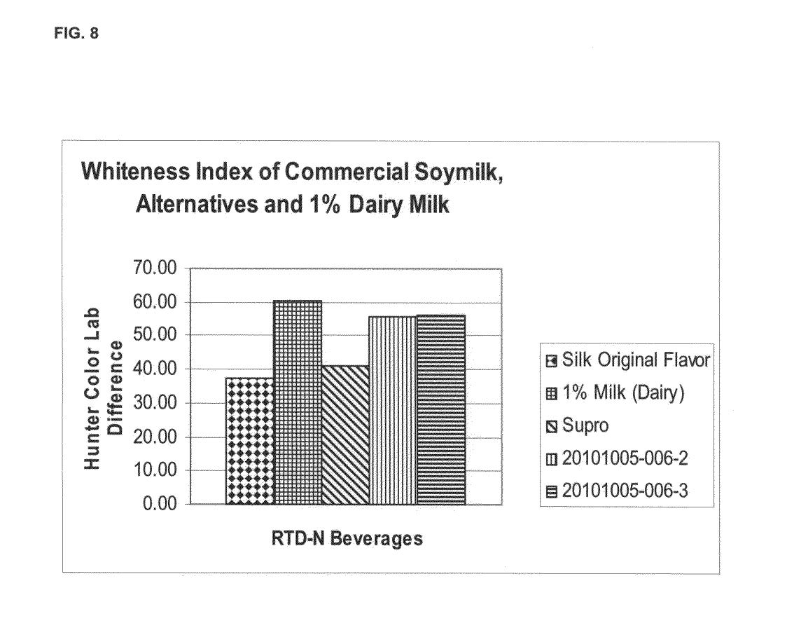

FIG. 8 is a bar graph showing 2-AFC Directional Difference Discrimination of Milk Alternatives with Neutralized Acid Soluble Protein (neutralized ASSP A and neutralized ASSP X) compared to Supro®120 Technology and commercial soy milk and 1% milk (cow's milk).

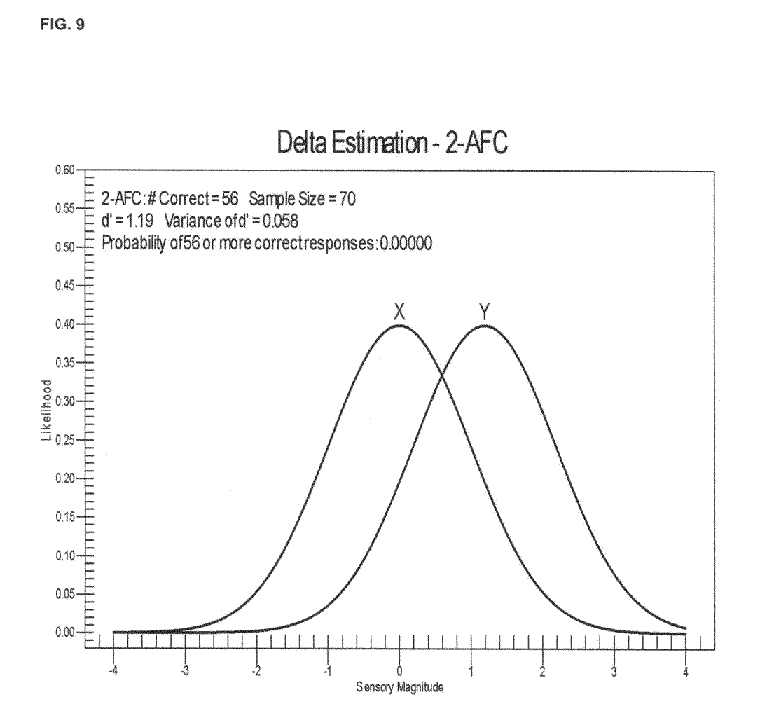

FIG. 9 is a graph showing responses for Example 3 as to which sample has “more soy flavor” using a computerized data collection system with Compuserve Five® version 5.2 software.

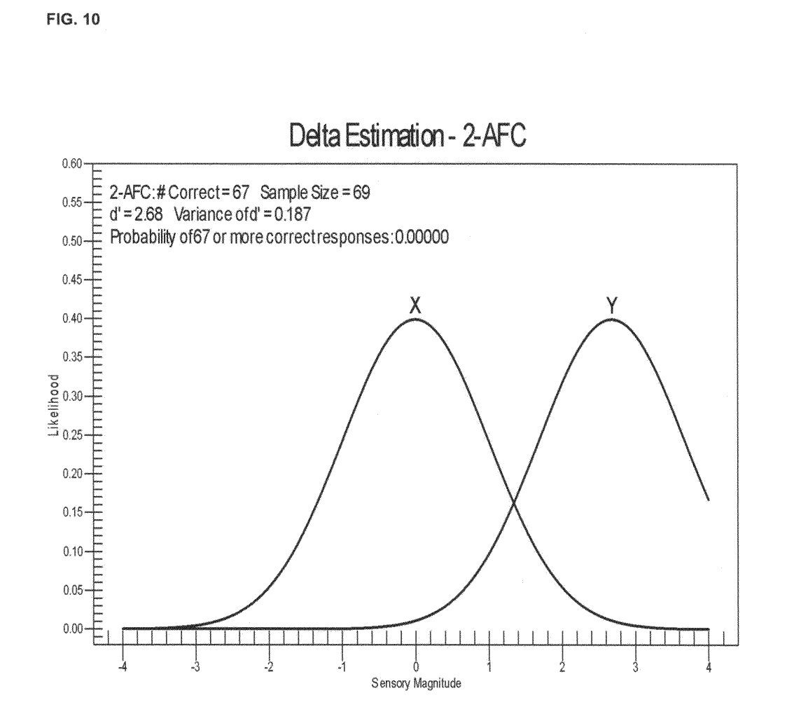

FIG. 10 is a graph showing responses for Example 3 as to which is the “whiter” sample using a computerized data collection system with Compuserve Five® version 5.2 software.

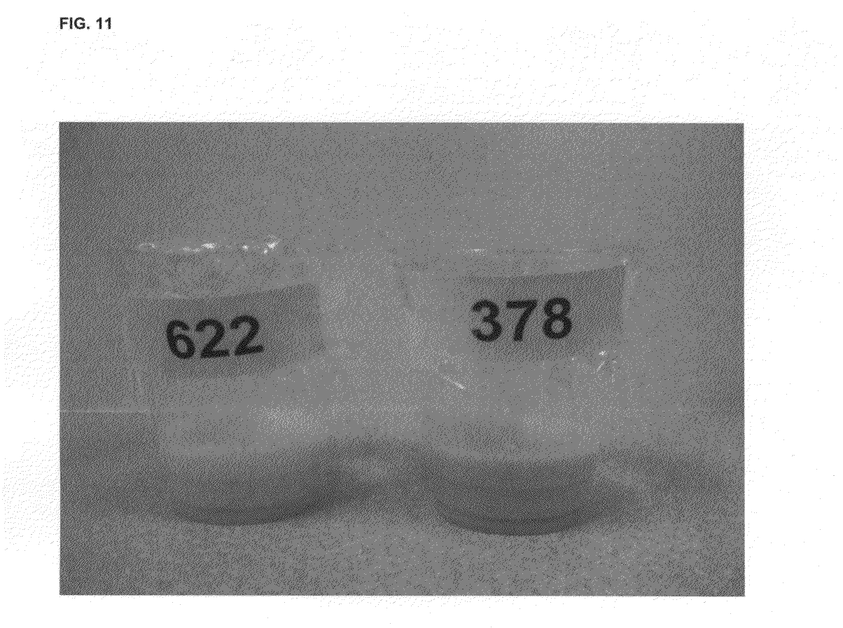

FIG. 11 is a photograph showing the results of the soymilk made in Example 3; the container labeled 622 is the ASSP soymilk made in Example 3 and the container labeled 378 is the Supro®120 soymilk.

### DETAILED DESCRIPTION OF THE INVENTION

### (I) Compositions

The acid soluble protein for use in the current invention can be an acid soluble protein isolate, an acid soluble protein concentrate, an acid soluble flour and combinations thereof. When an acid soluble protein isolate is used, the acid soluble protein isolate may be prepared as described in U.S. Pre-Grant Publication Nos. 20100215830, 20100215830, 20100203205, 20100203204, 20100179305, 20100098818, and 20050255226; all of which are incorporated herein by reference in their entirety).

In the present invention, the addition of strongly negatively charged ions, or other negatively charged substances, such as negatively charged chelating agents including but not limited to hydrocolloids, like the carrageenans, followed by neutralisation, results in a protein dispersion that is almost completely soluble in the neutral pH range. Judicious processing provides populations of protein particles and fat globules that fall into the optimum light scattering range for whiteness. These neutralized acid soluble proteins can be agglomerated for use in various food applications.

The formulations and manufacturing process used produce products whose characteristics are provided in the data provided separately in relation to whiteness index and sensory profiling that was done on the product. This formulation and method produced a new, unique product. The whiteness index resembles that of skim milk more closely than it does any of the products manufactured using conventional soy protein products, including Alpha® 5800, Supro® 120 and Supro® XF 8020, all available at Solae, LLC (St. Louis, Mo.). These products were considered some of the best ingredients for use in this type of application. The flavour profile showed considerably lower levels of the “soy/legume” attribute characteristic of soy beverages produced conventionally in general.

This technology can be extended to other non-acid applications. Examples include but are not limited to dairy drinks, smoothies and shakes, sports beverages, nutritional beverages, neutral dry-blended beverages, protein supplements; ready to drink neutral beverages, soymilks, flavored soymilks, infant formulas that may be spray dried, or liquid Ready-to-Feed (RTF) or concentrates for dilution. Also products destined for special medical purposes, such as enteral feeding by mouth or by feeding tube can be included. The beverage compositions are produced according to the standard industry recipes after the appropriate neutralization procedure as disclosed herein has been applied to the acid soluble protein.

With regard to a plant protein source, the plant may be grown conventionally or organically. The plant may also be a naturally occurring plant or a genetically engineered plant. By way of non-limiting example, suitable plants may include legumes, peas, canola, other legumes, and combinations thereof.

In particular aspects of the invention, the plant protein source is from soy. The soy protein source may be soybeans or any soy product, by-product, or residue derived from the processing of soybeans including, for example, soy meal, soy spent flakes, soy grits, and soy flour. The soy protein source may be used in the full-fat form, partially defatted form, or fully defatted form. The soy protein recovered from the soy protein source may be the protein naturally occurring in soybean or naturally occurring or modified protein in soybean as a result of genetic engineering. In other aspects of the invention, the soy protein source can be from a soybean with naturally or genetically altered lipid profiles, including for example, high stearic, high oleic, mid oleic, ultra low linolenic, low linolenic, etc. in order to further improve the flavor characteristics and whiteness of the neutral beverage.

A variety of additional ingredients may be added without departing from the scope and spirit of the invention. The remaining ingredients can include any ingredient known to one of skill in the art of making beverages. The edible material in the beverage composition may include but is not limited to fruit juice, sugar, milk, non-fat dry milk powder, caseinate, soy protein concentrate, soy protein isolate, whey protein concentrate, whey protein isolate, isolated milk protein, chocolate, cocoa powder, coffee, tea, and combinations thereof. The beverage composition may further comprise sweetening agents (such as glucose, sucrose, fructose, maltodextrin, sucralose, corn syrup, honey, maple syrup, stevia, etc.), flavoring agents (e.g., fruit flavors, chocolate flavors, vanilla flavors, etc.), emulsifying or thickening agents (e.g., lecithin, carrageenan, cellulose gum, cellulose gel, starch, gum arabic, xanthan gum and the like); stabilizing agents, lipid materials (e.g., canola oil, sunflower oil, high oleic sunflower oil, fat powder, etc.), preservatives (e.g., potassium sorbate, sorbic acid, and so forth); antioxidants (e.g., ascorbic acid, sodium ascorbate, etc.) coloring agents, vitamins, minerals, probiotics, omega-3 fatty acids, sterols, fibers, and combinations thereof.

(i) Antioxidant

For example, an antioxidant, antimicrobial agent, and combinations thereof may be an additional ingredient. An antioxidant additive includes, for example, BHA, BHT, TBHQ, rosemary extract, vitamins A, C and E and derivatives thereof. Additionally, various plant extracts such as those containing carotenoids, tocopherols or flavonoids having antioxidant properties, may be included to increase the shelf-life or nutritionally enhance the protein compositions. An antioxidant or antimicrobial agent may have a presence or combined presence at levels of from about 0.01% to about 10%, preferably, from about 0.05% to about 5%, and more preferably from about 0.1% to about 2%, by weight of the protein-containing materials.

(ii) Colorant

One or more colorants may be an additional ingredient. The colorant is mixed with the other ingredients or other methods known to one of ordinary skill in the art for coloring food products. Exemplary colorants that can be used are any colorant currently used in the food industry.

(iii) Flavoring Agent

One or more flavoring agents may be an additional ingredient. The flavoring agent may be mixed with the other ingredients or other methods known to one of ordinary skill in the art for flavoring food products. Exemplary flavorings that can be used are any flavoring agents currently used in the food industry.

(iv) Minerals or Amino Acids

One or more minerals or amino acids may be an additional ingredient. Suitable minerals may include one or more minerals or mineral sources. Non-limiting examples of minerals include, without limitation, chloride, sodium, calcium, iron, chromium, copper, iodine, zinc, magnesium, manganese, molybdenum, phosphorus, potassium, selenium, and combinations thereof. Suitable forms of minerals include, for example, soluble mineral salts, slightly soluble mineral salts, insoluble mineral salts, chelated minerals, mineral complexes, non-reactive minerals such as carbonate minerals, reduced minerals, and combinations thereof. Suitable amino acids include, for example, the essential amino acids, i.e., arginine, cysteine, histidine, isoleucine, leucine, lysine, methionine, phenylalanine, 7threonine, tryptophan, tyrosine, valine, and combinations thereof. Suitable forms of the amino acids include, for example, salts and chelates.

(v) Hydrocolloids

In general hydrocolloids are carbohydrates and are used as stand alone food ingredients, the agglomeration (binding of) these ingredients with acid soluble protein isolate will improve their nutritional quality while improving the functionality of the ingredient. Hydrocolloids can also be used to improve stability and mouthfeel of the final beverage.

### (II) The Process for Making the Neutralized Acid Soluble Protein

One process for making the neutralized acid soluble vegetable protein begins by hydrating the acid soluble vegetable protein for about 15 minutes in water at room temperature, between about 20° C. and about 25° C. Next, the chelating agent is added to the acid soluble vegetable protein while the acid soluble vegetable protein is at its native pH, thus acidic prior to neutralization. The slurry with the chelating agent added is mixed for about 10 minutes. The slurry turns opaque with the addition of the chelating agent. The pH of the slurry is then adjusted to about 7.5, where the slurry becomes translucent. The slurry is warmed to between about 60° C. and about 80° C. and may be homogenized. The final pH is checked and adjusted to pH between about 7.3 and about 7.4.

The following is a list of ingredients and a process that can be used to make the neutralized acid soluble soy protein of the present invention:

| | |
|---|---|
| Acid soluble soy protein | 100%, as is |
| Sodium hexametaphosphate | 8.9% or |
| Sodium citrate | 12.5% |
| Sodium hydroxide solution | as necessary to reach a neutral pH |
| Water | as needed for formulation |

1. the acid soluble soy protein was dispersed into water at room temperature (20-25° C.) using medium shear and allowed to hydrate for 15 minutes.
2. sodium hexametaphosphate (or sodium citrate) was added and mixed for 10 minutes.
3. the pH of the slurry was adjusted to 7.5
4. the slurry was warmed slightly to 25-30° C. and homogenized at 300 bar.
5. the pH of the slurry was checked and adjusted to pH 7.3 to 7.4 by adding 1.0 N sodium hydroxide solution (quantum satis) and mixing, thus forming the neutralized acid soluble soy protein.

The neutralized acid soluble protein may be heat processed and/or homogenized at between about 200 bar and about 230 bar, and chilled for use in neutral pH applications. Heat processing includes pasteurization, ultra high temperature treatment, sterilization, and combinations thereof.

The following is a list of ingredients and a process that can be used to make the neutralized acid soluble soy protein of the present invention:

| | |
|---|---|
| Acid soluble soy protein | 100%, as is |
| Sodium hexametaphosphate | 8.9% or |
| Sodium citrate | 12.5% |
| A suitable alkaline salt, such as sodium carbonate | as necessary to reach |
| | a neutral pH |

These ingredients are dry blended together or with other ingredients as needed, and used in the final formulation of the desired product.

### (III) Food Products

The neutralized acid soluble vegetable protein composition can be used in neutral beverages and food products such as extrudates, bars, soymilk, flavored soymilk, isotonic beverages, neutral dry blended beverages, neutral ready to drink beverages, infant formulas, weight loss beverages, liquid coffee creamers, powdered coffee creamers, sports nutrition beverages, nutritional supplemental beverages, clinical nutrition beverages, milkshake beverages, sweetened condensed milk, and combinations thereof.

### (IV) Sensory

### Whiteness Index

The “whiteness index” of a soy protein product refers to the color of the soy-protein-containing composition. Many soy protein-containing feed compositions will have, to varying degrees, a yellowish or brownish color. In general, the color of these compositions can be “improved,” i.e., the “whiteness index” of the product can be increased by the process of the present invention. In general, the whiteness index is determined using a colorimeter which provides the L, a, and b color values for the composition from which the whiteness index may be calculated using a standard expression of the Whiteness Index (WI), WI=L−3b. The L component generally indicates the whiteness or, “lightness”, of the sample; L values near 0 indicate a black sample while L values near 100 indicate a white sample. The b value indicates yellow and blue colors present in the sample; positive b values indicate the presence of yellow colors while negative b values indicate the presence of blue colors. The a value, which may be used in other color measurements, indicates red and green colors; positive values indicate the presence of red colors while negative values indicate the presence of green colors. For the b and a values, the absolute value of the measurement increases directly as the intensity of the corresponding color increases. Generally, the colorimeter is standardized using a white standard tile provided with the colorimeter. A sample is then placed into a glass cell which is introduced to the colorimeter. The sample cell is covered with an opaque cover to minimize the possibility of ambient light reaching the detector through the sample and serves as a constant during measurement of the sample. After the reading is taken, the sample cell is emptied and typically refilled as multiple samples of the same material are generally measured and the whiteness index of the material expressed as the average of the measurements. Suitable colorimeters generally include those manufactured by HunterLab (Reston, Va.) including, for example, Model # DP-9000 with Optical Sensor D 25.

Whiteness index measurements of milk or of a milk alternative beverage are determined using a HunterLab DP-9000 colorimeter including an optical sensor D-25, both manufactured by Hunter Associates Laboratory (HunterLab) (Reston, Va.). The results obtained using the Hunter Colorimeter are reported in units of L, a, and b. Whiteness Index is calculated from the L and b scale values using the following: Whiteness Index=L−3b.

In a consumer study conducted in 2002 (unpublished data), color, specifically whiteness, was determined to be a key driver of consumer liking among a series of 15 different beverages that varied in whiteness. Table 1 below shows that as calculated Whiteness Index (WI=L−3b) values increase, consumer liking of beverage appearance increases as does as the percentage of consumers that declare color of the beverages to be “Just About Right” when rated on a five point scale where 1 equaled “Much Too Dark”, 2 equaled “Somewhat Too Dark”, 3 equaled “Just About Right”, 4 equaled Somewhat Too Light”, and 5 equaled “Much Too Light”.

TABLE 1

| | Appearance | | |
|---|---|---|---|
| | Liking | | % “Just About |
| | mean score | Whiteness | Right” Ratings |
| | (N = 210 | Index | for Perception |
| | Consumers) | (WI = L − 3b) | of Color |
| Beverage “A” | 6.2 | 58.55 | 76 |
| Beverage “B” | 7.0 | 58.52 | 81 |
| Beverage “C” | 6.0 | 58.40 | 69 |
| Beverage “D” | 6.8 | 49.98 | 83 |
| Beverage “E” | 6.2 | 47.18 | 79 |
| Beverage “F” | 6.3 | 44.01 | 66 |
| Beverage “G” | 5.9 | 40.24 | 61 |
| Beverage “H” | 4.3 | 40.07 | 25 |
| Beverage “I” | 5.6 | 39.21 | 41 |
| Beverage “J” | 5.1 | 37.94 | 36 |
| Beverage “K” | 4.9 | 35.83 | 37 |
| Beverage “L” | 3.7 | 33.57 | 23 |
| Beverage “M” | 4.6 | 32.89 | 34 |
| Beverage “N” | 5.2 | 32.51 | 34 |
| Beverage “O” | 5.1 | 31.38 | 39 |

Correlation of calculated Whiteness Index values with Consumer Liking of Appearance (mean score from 200 consumers) and percentage of consumers rating products “Just About Right” in color using Pearson product moment correlation yields r coefficients of 0.76 and 0.84, respectively. Liking of Appearance and percentage of “Just About Right” responses yielded an r coefficient of 0.94. The Pearson product moment correlation coefficient, r, a dimensionless index that ranges from −1.0 to 1.0 inclusive and reflects the extent of a linear relationship between two data sets.

TABLE 2
Pearson Correlation Coefficients

| | Appearance Liking | WI |
|---|---|---|
| WI | 0.76 | |
| % JAR | 0.94 | 0.84 |

### Sensory Methodology

Directional Difference Test:

The objective of this test method is to determine with a given confidence level whether a difference exists in the perceived intensity of a specified sensory attribute between two samples. This test method does not address preference. The directional difference test is a forced-choice procedure; the panelists are not allowed the option of reporting “no difference.” Analysis of the results is based on binomial statistics. Tables for rapid analysis were prepared by Meillegard et al. (Meilgaard, M., Civille, G. V., Carr, B. T., Sensory Evaluation Techniques, 4th Edition, CRC Press, Inc., Boca Raton, Fla., 2007). A 2 Alternative Forced Choice (2AFC) variation of this test utilizes prior training through use of a warm-up reference sample to illustrate the specific sensory attribute assessors are asked to focus attention on (in this case, soy flavor intensity and whiteness). (American Society for Testing and Materials, ASTM International, Standard E 2164—Standard Test Method for Directional Difference Test, 2008).

### Milk Alternative Sensory Evaluations for Whiteness:

Samples are removed from the refrigerator and prepared for the sensory panel by pouring 2 ounce aliquots into coded 5 ounce clear plastic cups covered with clear Saran® wrap and held again under refrigerated conditions until serving to panelists. Sample cups are labeled with 3 digit random codes to prevent panelists from identifying any particular sample. The experiment was designed in such a way that two possible combinations were given: AB and BA. Panelists are presented with the two test samples and asked to look at the samples (without tasting) and select the “whiter” sample, recording their responses using a computerized data collection system with Compusense Five® Version 5.2 software. Of the 69 tested panelists, 67 (97%) were able to discriminate at a 99% level of Confidence, selecting (Supra® 120 Control sample) as “whiter in color”. The Thurstonian D′ value was equal to 2.68, where a Thurstonian D′ value of 1.0 represents a “Just Noticeable Difference”, depending on the sensitivity of the population tested, see FIG. 3.

### Soy Flavor Improved

In addition to the improved (whiter) color, the soy protein-containing composition produced by the processes in the present disclosure is said to have less of the “soy flavor” typical of other isolated soy protein technologies.

### Sensory Methodology for Soy Flavor

Directional Difference Test:

The objective of this test method is to determine with a given confidence level whether a difference exists in the perceived intensity of a specified sensory attribute between two samples. This test method does not address preference. The directional difference test is a forced-choice procedure; the panelists are not allowed the option of reporting “no difference.” Analysis of the results is based on binomial statistics. Tables for rapid analysis were prepared by Meillegard et al. (Meilgaard, M., Civille, G. V., Carr, B. T., Sensory Evaluation Techniques, 4th Edition, CRC Press, Inc., Boca Raton, Fla., 2007). A 2 Alternative Forced Choice (2AFC) variation of this test utilizes prior training through use of a warm-up reference sample to illustrate the specific sensory attribute assessors are asked to focus attention on (in this case, soy flavor intensity and whiteness). (American Society for Testing and Materials, ASTM International, Standard E 2164—Standard Test Method for Directional Difference Test, 2008).

### Milk Alternative Sensory Evaluations:

Samples are removed from the refrigerator and prepared for the sensory panel by pouring 3 ounce aliquots into coded 5 ounce Styrofoam cups with lids and held again under refrigerated conditions until serving to panelists. Sample cups are labeled with 3 digit random codes to prevent panelists from identifying any particular sample. Use of Styrofoam cups, lids, and straws prevents panelists from seeing the samples, thereby eliminating any expectation bias due to color or appearance of the samples. The experiment was designed in such a way that two possible combinations were given: AB and BA. Before assessing the test samples, panelists are given a Reference sample that illustrates “Soy Flavor”. A commercial soymilk (Silk™ Original flavor soymilk) is used as the reference for “Soy Flavor”, Panelists are then presented with the two test samples and asked to sip the samples through a straw and then select the sample that had “more soy flavor”, recording their responses using a computerized data collection system with Compusense Five® Version 5.2 software. Of the 70 tested panelists, 56 (80%) were able to discriminate at a 99% level of Confidence, selecting (Supro®120 Control sample) as having “more soy flavor”. The Thurstonian D′ value was equal to 1.19, where a Thurstonian D′ value of 1.0 represents a “Just Noticeable Difference”, depending on the sensitivity of the population tested, see FIG. 4.

### DEFINITIONS

To facilitate understanding of the invention several terms are defined below.

The term “acid soluble protein” refers to a protein that is mostly soluble at acidic pHs (7.0 and lower) more preferably at pH lower than 4.

The term “chelating agent” refers to any compound capable of providing negatively charged multivalent ions in solution, or carrying strongly charged groups or regions on its molecule, such that it can react with the positively charged groups on a protein soluble under acid conditions.

The term “native pH” refers to the pH of a solution of a protein alone when dispersed in distilled or deionised water.

The term “flavoring agent” refers to a food additive or ingredient that is added to a food system to enhance or impart a specific flavor or flavors.

The term “vitamin” refers to any of various organic substances that are essential in minute quantities to the nutrition of most animals and some plants, act especially as coenzymes and precursors of coenzymes in the regulation of metabolic processes but do not provide energy or serve as building units, and are present in natural foodstuffs or sometimes produced within the body (www.merriam-webster.com/dictionary 11/22/2010).

The term “antioxidant” refers to a substance that inhibits oxidation or reactions promoted by oxygen, peroxides, or free radicals (www.merriam-webster.com/dictionary 11/22/2010).

The term “mineral” refers to an inorganic substance (www.merriam webster.com/dictionary 11/22/2010).

The term “sugar” refers to any of various water-soluble compounds that vary widely in sweetness, including monosaccharides and oligosaccharides (www.merriam-webster.com/dictionary 11/22/2010).

The terms “soy protein isolate” or “isolated soy protein,” as used herein, refer to a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “soymilk” refers to an aqueous mixture of any one or more of the following, finely ground soybeans, soy flour, soy flakes, soy concentrate, isolated soy protein, soy whey protein, and aqueous extracts of any one or more of the following, soybeans, soy flakes and soy flour where insoluble material has been removed. Soymilk may comprise additional components including but not limited to fats, carbohydrates, sweeteners, colorants, stabilizers, thickeners, flavorings, acids, bases.

The term “soymilk powder” refers to a dewatered soymilk. Soymilk may be dewatered by many processes that include but are not limited to spray drying, tray drying, tunnel drying, and freeze drying.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to a comminuted form of defatted, partially defatted, or full fat soybean material having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen.

The term “milk” refers to animal milk, plant milk, and nut milk. Animal milk is a white fluid secreted by the mammary glands of female mammals consisting of minute globules of fat suspended in a solution of casein, albumin, milk sugar, and inorganic salts. Animal milk includes but is not limited to milk from cows, goats, sheep, donkeys, camels, camelids, yaks, water buffalos. Plant milk is a juice or sap found in certain plants and includes but is not limited to milk derived from soy, and other vegetables. Nut milk is an emulsion made by bruising seeds and mixing with a liquid, typically water. Nuts that can be used for milk include but are not limited to almonds and cashews.

The term “milk protein” refers to any protein contained in milk as defined above, including any fractions extracted from the milk by any means known in the art. Milk protein further includes any combinations of milk proteins.

The following examples are used herein to illustrate different aspects of this invention and are not meant to limit the present invention in any way. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the application is to be interpreted as illustrative and not in a limiting sense.

As used herein, “a” or “an” may mean one or more. As used herein when used in conjunction with the word “comprising,” the words “a” or “an” may mean one or more than one. As used herein “another” may mean at least a second or more. Furthermore, unless otherwise required by context, singular terms include pluralities and plural terms include the singular.

As used herein, “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, “comprising” and all its forms and tenses (including, for example, comprise and comprised) is synonymous with “including,” “containing,” or “characterized by,” and is inclusive or open-ended language and does not exclude an additional, unrecited element, step, or ingredient. As used herein, “consisting” and all its forms and tenses (including, for example, consist and consisted) is closed language and excludes any element, step, or ingredient not specified. As used herein, “consisting essentially of” and all its forms and tenses limits the scope of the invention to the specified element, step, or ingredient and those that do not materially affect the basic and novel characteristic(s) of the claimed invention. Applicants note that certain embodiments recite the transitional phrase “comprising.” Wherever this transitional phrase has been recited, the transitional phrase consisting or consisting essentially of have also been contemplated by the inventors and form part of the invention.

All patents and publications mentioned in this specification are indicative of the level of those skilled in the art to which the invention pertains. All patents and publications herein are incorporated by reference to the same extent as if each individual publication was specifically and individually indicated as having been incorporated by reference in its entirety.

### EXAMPLES

The examples are illustrative and are not meant to limit the present invention in any way and many changes that can be made without departing from the spirit and scope of the invention would be apparent to those skilled in the art.

### Example 1

### A Neutralized Acid Soluble Soy Protein

| | |
|---|---|
| Acid soluble soy protein | 100%, as is |
| Sodium hexametaphosphate | 8.9% or |
| Sodium citrate | 12.5% |
| Sodium hydroxide solution | as necessary to reach a neutral pH |
| Water | as needed for formulation the acid soluble |
| | soy protein was dispersed into water at |
| | room temperature (20-25° C.) using medium |
| | shear and allowed to hydrate for 15 minutes. |

1. sodium hexametaphosphate (or sodium citrate) was added and mixed for 10 minutes.
2. the pH of the slurry was adjusted to 7.5
3. the slurry was warmed slightly to 25-30° C. and homogenized at 300 bar. the pH of the slurry was checked and adjusted to pH 7.3 to 7.4 by adding sodium hydroxide solution and mixing, thus forming the neutralized acid soluble soy protein.

### Example 2

### Milk Alternative Beverage (Soymilk)

Example 2 compares and evaluates two acid soluble soy protein isolates, two commercial soy protein isolates, and one soy protein concentrate in a formulated milk alternative beverage (soymilk). This example was done to determine if an acid soluble soy protein isolate could be neutralized to pH of 7.2 to 7.5 and a soymilk be subsequently prepared with improved color and flavor.

### Ingredients Used in Example 2

### Proteins

1. Acid soluble soy protein A (called ASSP A). Protein content is 93.1% “as is basis”.
2. Acid soluble soy protein X (called ASSP X). Protein content is 92.2 “as is basis”.
3. Supro® 120 from Solae, LLC. Protein content is 87.7 “as is basis”.
4. Supro® XF8020 soy protein isolate from Solae, LLC. Protein content is typically 87% “as is basis”
5. Alpha® 5800 (soy protein concentrate) from Solae, LLC. Protein content is typically 78% “as is basis”.

### Other Ingredients

### 6. Water

7. Potassium citrate, monohydrate
8. Sodium citrate, dihydrate
9. Dipotassium phosphate

### 10. Sugar

### 11. Maltodextrin, 15DE

### 12. Mixed Carrageenans.

13. Magnesium phosphate, dibasic
14. Sodium chloride

### 15. Sunflower oil

16. Antifoam, food grade

### Formulation

TABLE 3
Formulation for a milk alternative (soy milk) containing 3.2% protein
and 1% fat for evaluation of two experimental soy protein isolates,
Supro ®120, Alpha ® 5800, and Supro ®XF8020 is provided.

| | Supro ® | Supro ® | Alpha ® | Alpha ® | Supro ® | Supro ® |
|---|---|---|---|---|---|---|
| | 120 | 120 | 5800 | 5800 | XF | XF |
| INGREDIENTS | (%) | (gm) | (%) | (gm) | (%) | (gm) |
| Water | 88.728 | 106,47.36 | 88.286 | 1,0594.32 | 88.511 | 10,621.32 |
| Potassium citrate, | 0.200 | 24.00 | 0.200 | 24.00 | 0.200 | 24.00 |
| monohydrate | | | | | | |
| Sodium citrate, | 0.131 | 15.72 | 0.131 | 15.72 | 0.131 | 15.72 |
| dehydrate | | | | | | |
| Dipotassium phosphate | 0.050 | 6.00 | 0.050 | 6.00 | 0.200 | 24.00 |
| Supro ® 120 (87.4%) | 3.661 | 439.32 | 0.000 | 0.00 | 0.000 | 0.00 |
| Alpha ® 5800 (78%) | 0.000 | 0.00 | 4.103 | 492.36 | 0.050 | 6.00 |
| Supro ® XF8020 (87%) | 0.000 | 0.00 | 0.000 | 0.00 | 3.678 | 441.36 |
| ASSP A (93.1%) | 0.000 | 0.00 | 0.000 | 0.00 | 0.000 | 0.00 |
| ASSP X (92.2%) | 0.000 | 0.00 | 0.000 | 0.00 | 0.000 | 0.00 |
| Sugar | 2.500 | 300.00 | 2.500 | 300.00 | 2.500 | 300.00 |
| Maltodextrin, 15DE | 3.521 | 422.52 | 3.521 | 422.52 | 3.521 | 422.52 |
| Mixed Carageenans | 0.030 | 3.60 | 0.030 | 3.60 | 0.030 | 3.60 |
| Magnesium phosphate, | 0.138 | 16.56 | 0.138 | 16.56 | 0.138 | 16.56 |
| dibasic | | | | | | |
| Sodium chloride | 0.041 | 4.92 | 0.041 | 4.92 | 0.041 | 4.92 |
| Sunflower oil | 1.000 | 120.00 | 1.000 | 120.00 | 1.000 | 120.00 |
| Total | 100.00 | 12,000.00 | 100.00 | 12,000.00 | 100.00 | 12,000.00 |

TABLE 3
Formulation for milk alternative (soy milk) containing 3.2%
protein and 1% fat for evaluation of two experimental soy protein
isolates, ASSP A and ASSP X is shown in this table.

| | ASSP A | ASSP A | ASSP X | ASSP X |
|---|---|---|---|---|
| INGREDIENTS | (%) | (gm) | (%) | (gm) |
| Water | 88.952 | 10,674.22 | 89.016 | 10,681.92 |
| Potassium citrate, | 0.200 | 24.00 | 0.200 | 24.00 |
| monohydrate | | | | |
| Sodium citrate, dihydrate | 0.131 | 15.72 | 0.131 | 15.72 |
| Dipotassium phosphate | 0.050 | 6.00 | 0.050 | 6.00 |
| Supro ® 120 (87.4%) | 0.000 | 0.00 | 0.000 | 0.00 |
| Alpha ® 5800 (78%) | 0.000 | 0.00 | 0.000 | 0.00 |
| Supro ® XF8020 (87%) | 0.000 | 0.00 | 0.000 | 0.00 |
| ASSP A (93.1%) | 3.4372 | 412.46 | 0.000 | 0.00 |
| ASSP X (92.2%) | 0.000 | 0.00 | 3.373 | 404.76 |
| Sugar | 2.500 | 300.00 | 2.500 | 300.00 |
| Maltodextrin, 15DE | 3.521 | 422.52 | 3.521 | 422.52 |
| Mixed Carageenans | 0.030 | 3.60 | 0.030 | 3.60 |
| Magnesium phosphate, | 0.138 | 16.56 | 0.138 | 16.56 |
| dibasic | | | | |
| Sodium chloride | 0.041 | 4.92 | 0.041 | 4.92 |
| Sunflower oil | 1.000 | 120.00 | 1.000 | 120.00 |
| Total | 100.00 | 12,000.00 | 100.00 | 12,000.00 |

Process for Soymilk Using Supro®120, Alpha®5800, and Supro®XF8020.

1. Disperse buffering salts (potassium, sodium citrate and potassium phosphate) in water at 38° C. (100° F.).
2. Disperse soy protein ingredient in water using moderate shear. After lumps are dispersed, increase temperature to 77° C. (170′F). Continue mixing on slow speed for 15 minutes. Add food grade antifoam if needed.
3. Dry blend, sucrose, maltodextrin, stabilizers, salt, and magnesium phosphate. Disperse in protein slurry. Continue mixing and maintain temperature 74° C.-77° C. (165° F.-170° F. for 10 minutes.
4. Add sunflower oil to slurry and continue mixing at slow speed until homogenous for approximately three minutes.
5. Adjust pH to 7.2 using either 50% citric acid or 45% KOH, whichever is necessary.
6. Heating parameters for Ultra High Temperature (UHT) process follows:
a. Preheat slurry to 104° C. (220° F.) and UHT process indirect heat at 141° C. (286° F.) for 6 seconds.
b. Cool product to 72° C. (162° F.) homogenize at 500 psi (35 Bar) second stage; 2500 psi (173 Bar) first stage.
c. Cool product to 31° C. (88° F.) and package in 250 ml sterilized bottles. Cool and store refrigerated at 4° C.

### Process for Soymilk Using Acid Soluble Soy Proteins (ASSP)

1. Disperse acid soluble protein ingredient in water 38° C. (100° F.) (using moderate shear. After all lumps are dispersed, adjust pH to 7.2 with sodium hydroxide. Add Dow Corning 1520-US antifoam if needed and mix for 15-20 minutes.
2. Disperse buffering salts (potassium, sodium citrate and potassium phosphate) in protein slurry.
3. Increase temperature to 77° C. (170° F.). Continue mixing on slow speed for 15 minutes.
4. Dry blend sucrose, maltodextrin, stabilizer, salt, magnesium phosphate. Disperse in protein slurry. Continue mixing and maintain temperature at 74° C.-77° C. (165° F.-170° F.) for 10 minutes. Keep pH in the 7.2 to 7.5 range.
5. Add sunflower oil to slurry and continue mixing at slow speed until homogenous for approximately three minutes.
6. Add flavoring agents and continue mixing for one minute (if in formula).
7. Adjust pH to 7.2-7.5 using either 50% citric acid or 45% KOH whichever is necessary.
8. Heating parameters for Ultra High Temperature (UHT) Process as follows:

a) Preheat slurry to 104° C. (220° F.) and UHT process indirect heat at 141° C. (286° F. for 6 seconds.

b) Cool product to 72° C. (162° F.) homogenize at 500 psi (35 Bar) second stage; 2500 psi (173 Bar) first stage.

c) Cool product to 31° C. (88° F.) and package in 250 ml sterilized bottles. Cool and store refrigerated.

### Evaluation:

TABLE 4
The color of the soymilks was measured with a Hunter
Color Difference Meter for L, a, and b values. The Whiteness
Index (WI) was calculated using L − 3b = WI.
The pHs of soymilks are provided in this table.

| PROTEIN USED IN | | COLOR (Hunter) | | | Whiteness |
|---|---|---|---|---|---|
| FORMUALATION | pH | L | a | B | Index |
| Supro ® 120 | 7.33 | 76.64 | −0.05 | 9.34 | 48.62 |
| Alpha ® 5800 | 7.29 | 79.08 | 0.38 | 12.21 | 42.45 |
| Supro ® XF 8020 | 7.27 | 80.27 | 1.08 | 11.08 | 47.03 |
| ASSP A | 7.07 | 85.64 | −1.54 | 8.60 | 59.84 |
| ASSP X | 7.13 | 85.77 | −1.39 | 8.97 | 58.86 |
| Skim Milk | 6.70 | 87.67 | −4.89 | 8.70 | 61.57 |

The whiteness of the soy milks made with acid soluble proteins (ASSP A and ASSP X) were nearly equivalent to that of skim milk as shown in FIGS. 5 and 6. Soymilk made with Supro®120 had a slightly higher Whiteness Index than soymilk made with Alpha®5800 and Supro®XF5020.

The soymilks made with acid soluble proteins (ASSP A and ASSP X) had sediment indicating the proteins were not completely soluble, see FIG. 6. This indicates that the acid soluble proteins were not completely solubilized in the adjustment of pH from 3.0 to pH 7.2-7.5. The soymilks made with acid soluble proteins also had a gritty mouth feel, thus indicating the protein was not completely soluble.

The other soy protein isolates had good suspension.

### Observation/Calculations

The soy milks made with traditional soy protein isolates had smoother mouthfeel than the soymilks made with the neutralized acid soluble soy protein isolates. These soymilks were gritty in mouth feel and had settling of the protein. The soymilk with the gritty mouth feel was further homogenized at 4000 PSI (280 BAR) and the mouth feel was improved (smoother).

### Results

A summary of the sensory profiling of the soymilks is as follows:

1. Descriptive Profiling Panelists found the two acid soluble products to be significantly different in appearance, flavor, and textural properties compared to existing technology Supro®120, Supro®XF8020, and Alpha®5800.
2. Both acid soluble protein variants had less Soy/Legume but were stronger in Grain aromatics and were described by some panelists (29%) as having a “Soapy” aromatic at the strength of the baking soda note in a saltine cracker. Sample ASSP “A” was also described as having “Fruity” aromatics at an intensity of 2.0, detected by 43%. Both acid soluble protein samples were stronger in Astringency and Chalky Mouthcoating.
3. The two acid soluble protein variants had significantly more particles, perceptible both in size and amount, compared to the other commercial proteins.
4. Both acid soluble protein variants were visibly whiter, and more similar to milk in appearance, however samples settled out of solution rather quickly. Alpha®5800 and Supro®XF8020 had more Soy/Legume Aftertaste than the acid soluble proteins (after 2 minutes).

### Conclusions

The soymilks made with acid soluble soy protein isolate were whiter in color and had reduced soy flavor odor/flavor in comparison to the soy milks made with Supro®120, Alpha®5800, and Supro®XF8020. However, the mouth feel had a gritty character.

### Example 3

### Formulation and Process Change to Increase the Solubility of Acid Soluble Soy Protein at pH 7.5 to Prepare Soymilk with Improved Suspension and Mouthfeel

In Example 2 it was shown that soymilk could be prepared with acid soluble soy protein isolate. However, the mouth feel was gritty and the products had poor suspension resulting sediment rather quickly. It was found that sodium hexametaphosphate could be used as a sequester agent to improve the solubility of the acid soluble soy protein at pH 7.5.

### Ingredients Used in Experiment

### Protein

1. Experimental soy protein isolate from ASSP X (called ASSP X). Protein content is 92.2 “as is basis”.

### Other Ingredients

### 2. Water

3. Potassium citrate, monohydrate
4. Sodium hexametaphosphate
5. Magnesium phosphate

### 6. Sugar

### 7. Maltodextrin, 15DE

8. Iota carageenan.
9. Lambda carrageenan

### 10. Cellulose gum

11. Magnesium phosphate, dibasic
12. Sodium chloride

### 13. Sunflower oil

14. Antifoam, food grade

### Formulation

TABLE 5

| | | | | | Formula 3 | |
|---|---|---|---|---|---|---|
| | | | Formula 2 | | ASSP X with mixed | |
| | Formula 1 | | ASSP X with mixed | | Carageenans | |
| | Supro ®120 | | Carageenans | | and cellulose gum | |
| | (%) | gm/ | (%) | gm/ | (%) | gm/ |
| Ingredients | as is | 10000 g | as is | 10000 g | as is | 10000 g |
| Deionized Water | 88.529 | 8852.90 | 88.736 | 8873.60 | 88.471 | 8847.10 |
| Sodium Hexametaphosphate | 0.000 | 0.00 | 0.300 | 30.00 | 0.300 | 30.00 |
| ASSP X (94.86%) | 0.000 | 0.00 | 3.373 | 337.30 | 3.373 | 337.30 |
| Supro ®120 | 3.422 | 342.20 | 0.000 | 0.00 | 0.000 | 0.00 |
| Sugar | 2.750 | 275.00 | 2.750 | 275.00 | 2.750 | 275.00 |
| Maltodextrin, 15DE | 3.521 | 352.10 | 3.521 | 352.10 | 3.521 | 352.10 |
| Potassium Citrate | 0.200 | 20.00 | 0.000 | 0.00 | 0.000 | 0.00 |
| Magnesium Phosphate | 0.038 | 3.80 | 0.000 | 0.00 | 0.000 | 0.00 |
| Salt | 0.030 | 3.00 | 0.000 | 0.00 | 0.000 | 0.00 |
| Iota-carageenan | 0.010 | 1.00 | 0.000 | 0.00 | 0.000 | 0.00 |
| Lambda carageenan | 0.000 | 0.00 | 0.070 | 7.00 | 0.035 | 3.50 |
| Cellulose gum | 0.250 | 25.00 | 0.000 | 0.00 | 0.300 | 30.00 |
| Sunflower oil High Oleic | 1.000 | 100.00 | 1.000 | 100.00 | 1.000 | 100.00 |
| Vanilla flavour | 0.25 | 25.00 | 0.25 | 25.00 | 0.25 | 25.00 |
| Total: | 100.00 | 10,000.00 | 100.00 | 10,000.00 | 100.00 | 10,000.00 |

### Process

1. The acid soluble soy protein ingredient was dissolved in water at 38° C. (100° F.) using moderate shear. After all lumps were dispersed (about 20 minutes), sodium hexametaphosphate was added and the slurry was mixed for 15 minutes further. At this point, the pH was in the range of 4.7 to 4.9 and the slurry was opaque. The pH was adjusted to 7.5 with 1.0 N sodium hydroxide (for formula 1, Supro 120, potassium citrate and magnesium phosphate are added without sodium hexametaphosphate). At pH 7.5 the ASSP X slurry became translucent. Food grade antifoam was added when foam levels became problematic, and mixing continued for another 30 minutes.
2. The temperature was raised to 77° C. (170° F.). Mixing continued at low speed for 15 minutes. The pH was maintained between 7.2 and 7.5.
3. The protein slurries were cooled to 5° C. and left in a refrigerator at 5° C. overnight.
4. The following day, protein slurries were removed from the refrigerator and heated to 77° C. (170° F.). The slurries were then homogenized at 300 bar (4200 psi)
5. The appropriate amount of protein slurry (i.e. 9240.9 grams for ASSP X) per batch was weighed out.
6. Sucrose, maltodextrin, stabilizer, salt and magnesium phosphate (where used) were dry blended together and then dispersed into the protein slurry. Mixing continued and the temperature was maintained at 74° C.-77° C. (165° F.-170° F.) for 10 minutes. The pH was maintained in the 7.2 to 7.5 range.
7. Sunflower oil was added to the slurry mixing continued at moderate speed until a homogeneous appearance developed (approximately three minutes). The pH was adjusted to 7.2-7.5 using either 50% citric acid or 45% KOH, whichever was necessary and then the product was heat processed.
8. Heat processing conditions for the Ultra High Temperature (UHT) process were as follows:

a. Slurry was homogenized at 500 psi (35 Bar) second stage; 2500 psi (173 Bar) first stage and then preheated to 104° C. (220° F.) and then heated indirectly to 141° C. (286° F.) for 6 seconds.

b. Product was cooled firstly to 72° C. (162° F.) and then to 3° C. (37° F.) and immediately packaged aseptically in a laminar air flow cabinet in 250 ml sterilized bottles.

c. Bottles were packed in ice-water and then passed into refrigerated storage.

TABLE 6

| | Hunter Lab. Colour | | | WHITENESS |
|---|---|---|---|---|
| SOYMILK | L | A | b | INDEX |
| Formula 1 | 74.31 | 1.94 | 11.18 | 40.78 |
| Supro ®120 | | | | |
| Formula 2 | 83.68 | −1.56 | 9.34 | 55.65 |
| ASSP X | | | | |
| Formula 3 | 84.03 | −0.81 | 9.34 | 56.00 |
| ASSPX | | | | |
| Silk ™ | 77.65 | 1.13 | 13.42 | 37.4 |
| Original | | | | |
| Flavour | | | | |
| 1% fat dairy | 90.25 | −3.34 | 9.92 | 60.50 |
| milk | | | | |

### Purpose of Test

To determine if untrained panelists can discern a significant difference in soy flavor and color (whiteness) of a new proprietary isolate technology when compared directly to Supro® 120 (existing technology) using a 2 alternative forced choice (2-AFC) directional difference test, see Table 6 above for Whiteness Index and FIG. 7 for soymilk samples made.

TABLE 7
Description of Samples:

Detailed Description of Variants to be Tested
Supro ®120 Control
Test 1: ASSP + GP109.7%

### Methodology:

Judges: 70 externally recruited consumers and Solae employees recruited through the www.tasteofsolae.com website that met requested selection criteria.

Test Type:

2-AFC Directional Difference Discrimination of Milk Alternatives, focusing on Soy Flavor Intensity and Whiteness. A Soy Flavor Reference sample was served prior to evaluation (Silk™ Original Commercial Soymilk). The 2-AFC test utilizes standard directional difference protocols with added direction on a specific sensory attribute to focus attention on (in this case, soy flavor intensity), see FIG. 8.

Sample Preparation: Soy Flavor Evaluation:

Milk alternative beverages were poured into coded styrofoam cups with lids and held refrigerated until serving. Samples were served in coded white styrofoam cups with lids in order to mask any appearance differences that may have biased discrimination of the samples. Panelists were instructed to sip samples through straws and were not permitted to look at the products.

Whiteness Evaluation:

Milk alternative beverages were poured into re-coded clear plastic cups, covered with clear Saran® wrap and held refrigerated until serving.

Experimental Design Two possible combinations were given: AB and BA

a. Summary of Findings

Soy Flavor:

80% of the panelists tested were able to discriminate at a 99% level of Confidence between Supro 120 and ASSP, selecting Supro 120 as the sample having more “Soy Flavor” as defined by a Reference of Silk Original soymilk. Thurstonian D′=1.19. As a general rule, a Thurstonian D′ value=1.0 represents a “Just Noticeable Difference”, depending on the sensitivity of the population tested.

Whiteness:

97% of the panelists tested were able to discriminate at a 99% level of Confidence between Supro 120 and ASSP, selecting ASSP as the “Whiter” sample. Thurstonian D′=2.68. As a general rule, a Thurstonian D′ value=1.0 represents a “Just Noticeable Difference”, depending on the sensitivity of the population tested.

### Detailed Findings

TABLE 8

| | Samples | |
|---|---|---|
| | Which sample has more | Which Sample is |
| | “Soy Flavor”? | “Whiter” in color? |
| Supro ®120 Control | 56 | 2 |
| ASSP Test 1 | 14 | 67 |
| Total | 70 | 69 |
| Percentage | 80% | 97% |
| Significance (p-value) | 0.001 | 0.00001 |

Test #1: Which sample has more “Soy Flavor”?, see FIG. 9. Sample X is formula 1 made with Supro®120 and sample Y is formula 2 made with ASSP and hexametaphosphate.

Test #2: Which sample is “Whiter” in color?, see FIG. 10. Sample X is formula 1 made with Supro® 120 and sample Y is formula 2 made with ASSP and hexametaphosphate.

TABLE 9
SUMMARY OF COMMENTS

| Control Supro ® 120 | Test - ASSP |
|---|---|
| 388 is more vanilla flavored. | bitter yucky - made me pucker like a sour flavor would |
| 388 had more of a grainy taste and stronger aftertaste | has more of a tart flavor versus 388 tasted sweeter but not soy |
| | flavor |
| 388 has a more pleasant taste, is more flavorful and less | is stronger aftertaste . . . sweeter |
| astringency than the other sample | |
| 388 has a more pleasant taste. The other sample was bitter and | It has a slightly stronger flavor - slightly chalkier flavor. It felt a |
| a tiny bit sour. 388 has a more pleasant aftertaste | little thicker in the mouth than the first. |
| 388 has more of a beany soy flavor | It is not as overpowering. Mouthfeel is about the same. |
| 388 is closer to the soy flavor provided and does not have the | It was smoother with cream taste thicker and not so much |
| intense amount of sweetness as sample 215. 388 is slightly | water. it was just the right taste of sweetener. |
| watered down compared to the soy flavor. | |
| 388 is more mild in flavor. 215 had a bitter, medicine like taste. | it was much more flavorful and sample 388 was more chalky |
| 388 is not as sweet and has more soy flavor | less vanilla characteristics |
| 388 is stronger, a little thicker and has a slightly stronger soy | lighter flavor |
| taste. | |
| A bit sweeter, less bitter than 215 (very sour putrid), 388 has | Mouthfeel seems a bit smoother/richer but there is a very slight |
| more dairy notes and a thicker mouthfeel. | bitter aftertaste which I associated with the ‘soy flavor’ sample. |
| better taste | not as sweet |
| creamy | Sample 215 had less of a malty flavor |
| Feels a little thicker or slightly grainy mouthfeel. Definitely more | Sample 388 has more flavor and a thick consistency than |
| soy flavor. | sample 215. # 215 was more like water with very little flavor |
| Flavor was not ‘sludgy’ . . . good taste not offensive. Other sample | the other sample (to me) didn't contain that much soy |
| was offensive. | |
| Had closer to the sample taste and feel | 215 seemed more bitter. |
| Had the soy flavor after taste. | |
| has a milky taste and feels smooth | |
| has green and earthy notes | |
| I tasted more soy flavor in sample 388. I didn't detect any soy | |
| flavor in the other. | |
| I taste more of a soy flavor in this sample | |
| it has the kind of soy, grassy, grain-like taste. Very distinctive. | |
| It is a blend taste with no flavor | |
| It is richer and smoother than the other sample, which had a | |
| sharp and harsh flavor. | |
| It is smoother and sweeter than soy. | |
| It taste similar to my original sample I tasted. The other sample | |
| 215 has a flowery taste to it and a very silky mouthfeel. | |
| It tastes more like soy. and more natural tasting. not sweet like | |
| the other sample which also had a chemical taste. | |
| It was not as bitter as the first sample and more creamy | |
| Just felt 388 had a stronger flavor! | |
| less vanilla flavor and seems thinner | |
| more substantial smoother flavor | |
| Sample 388 is more pleasant like the soy sample and easy to | |
| swallow. Sample 215 was completely different and soured | |
| tasting. | |
| sample 388 is sweeter and taste more like the sample with the | |
| nuttier flavor. | |
| Sample see has the sweet, somewhat flat flavor while 215 is | |
| sharp and more astringent | |
| seems to be flavorful the other was not as strong | |
| smoother, less bitter, sweeter, had a bit of ‘play dough’ taste to it | |
| though, the other sample tasted more industrial or chemical - | |
| not pleasant | |
| soy flavor is more evident | |
| stronger soy note | |
| Taste too much like water without any flavor . . . | |
| tastes like soy milk usually does | |
| Tastes more similar to soy reference. The other one (215) has | |
| more of a medicine-like taste, seemingly masking the soy flavor. | |
| The flavor was closer to the soy flavor, it powdery though . . . | |
| the flavor was stronger and more sweet. The second sample | |
| had a very artificial taste (aftertaste) and tasted least like the | |
| control sample. | |
| the other one had a strong artificial taste to it. | |
| the other sample seemed sweeter almost like juice. the sample | |
| I chose was les sweet and smoother. | |
| the other sample taste is too strong. 388 was like soy | |
| The other sample tastes more like vanilla than plain soy | |
| the sample 388 is less sweet and has more soy flavor . . . the | |
| mouth is more pleasant and slightly thicker | |
| They all taste different, but hard to tell which one of the two is | |
| more like soy | |
| thicker. sweeter. | |
| This has a bitter less sweet taste, lots of after taste | |
| unfortunately. | |
| This sample had a nutty flavor. The other sample was more | |
| mild. | |
| this sample unfortunately tasted like play dough. the other | |
| sample had better vanilla flavoring | |

TABLE 10
Whiteness Test Comments

| Control Supro ®120 | Test - ASSP |
|---|---|
| 378 almost looks dirty. 622 looks cleaner. | # 622 has more of a milk appearance than the other |
| 378 looks darker and less appealing than 622 which more resembles | 622 is whiter, but also looks more like regular milk. |
| dairy milk | |
| 378 looks likes it would have a lot more of soy flavoring than the next. | 622 sample definitely had a whiter appearance. the other sample |
| | appeared brownish |
| a bit dark in color and would not be appealing for me. | 622 vs 378 looks more like milk that is more appealing to the eye. |
| A bit darker | Do they have the same concentration? |
| brownish color | extremely lighter color |
| color looks too dark | Has an appearance that it might be thinner and more watery in |
| | consistency, but resembles milk more so than the other sample |
| darker color, looks more like some of the soy milk I have bought. | I like soy products, the slight brown color does not deter me |
| | from drinking soy milk. 622 might appeal more to people who |
| | think cow's milk is better than soy. It looks just like cow's milk. |
| darker in color than the first, looks less like milk | It is a true white looks like milk while sample 378 looks like an |
| | almond color |
| darker than I would prefer | It looks like skim milk and would be more appealing |
| Grey/brown in color, looks muddy and has a higher viscosity than 622 | It looks watery and milky in appearance. |
| Has a brown tint to it | like the light color |
| I would be scared to drink that if it wasn't chocolate flavored | look more appetizing and more like milk |
| If I had to pick one to drink I would choose sample 378, sample | Looks clean and white. |
| 622 seems watery and displeasing to the eye. | |
| If I poured 378 out of a carton, I would think it was spoiled. | looks like I would expect soy milk to look like |
| It is darker as if it has been flavored. | looks like it has been diluted with a lot of water |
| It is too dark in color | looks like milk |
| It looks a little ‘burnt’ in color and almost looks like scalded milk | looks like skim milk |
| that has been cooked too long. | |
| it looks cloudy and dirty-not appealing | looks like soy milk but looks a little thin |
| looks darker | looks like watered down milk |
| looks like milk used after cereal | looks more dilute |
| Looks more caramel flavor which looks to tastes better (did not taste) | looks more like milk |
| Looks murky and unattractive. | looks more like milk than 378 |
| more tan coloring, but thicker . . . actually looks more like soy | Looks more like milk. |
| Much more taupe than white. | looks more like skim milk |
| pinker . . . looks like dirty milk . . . like when you are eating cereal. | Looks the most like I think milk/soy milk should |
| suggest vanilla flavor | Much brighter white, similar to milk. Looks very appealing to consume |
| the brownish color it does not look as fresh as the other sample | Much more visually appealing |
| The color is weird - too dark | nice color |
| The consistency and color of this sample look more like soy milk. | pasty white, but very thin looking . . . |
| This looks more like baby formula - Similac from 1998 | sample 622 looks more like regular milk |
| This sample is more yellow in color. | The color is whiter and appears more creamy |
| this sample is too dark in color . . . | This is as white as dairy, but has a more watery look, like skim milk |
| This sample looks creamier, more of a richer desert look to it. | This is more appetizing. The other looks more earthy and less like |
| | regular milk |
| while it is not a true white it is whiter than sample | this looks more desirable because it's whiter . . . look's like milk. |
| | This looks more like milk. |
| | This looks more like the soy milk I'm use to . . . |
| | This sample appears to look like skim milk. |
| | This sample is lighter. Looks more like milk would look. |
| | this sample looks more like soy milk to me than the other sample |
| | visually I would want to try the 1 I chose |
| | White and slight watery look |
| | whiter, looks more like what you'd expect |
| | whiter. looks more like milk than the other sample |

Picture of sample presentation for Whiteness Directional Difference Test: Half of the panelists were shown the order depicted in FIG. 11, and the other half received sample #378 on the left and #622 on the right.

### Example 4

### Liquid Coffee Creamer, Comparing ASSP X with the Best Conventional Alternative Protein

TABLE 11
Liquid UHT Non-Dairy Creamer Formula

| | SUPRO ®XF8021 | | ASSP X | |
|---|---|---|---|---|
| | % | g per | % | g per |
| Ingredient | as is | 10000 g | as is | 10000 g |
| Water | 77.62 | 7762.25 | 77.57 | 7757.15 |
| Corn syrup solids, 25DE | 11.00 | 1100.00 | 11.00 | 1100.00 |
| Canola or sunflower oil | 9.50 | 950.00 | 9.50 | 950.00 |
| SUPRO XF 8021 | 0.57 | 57.00 | 0.00 | 0.00 |
| ASSP X | 0.00 | 0.00 | 0.57 | 57.00 |
| Sodium hexametaphosphate | 0.00 | 0.00 | 0.05 | 5.10 |
| Dipotassium phosphate | 0.35 | 35.00 | 0.35 | 35.00 |
| Sodium Stearoyl Lactylate | 0.15 | 15.00 | 0.15 | 15.00 |
| Polysorbate 60 | 0.15 | 15.00 | 0.15 | 15.00 |
| Natural Milk flavour | 0.45 | 45.00 | 0.45 | 45.00 |
| Natural and Artificial | 0.20 | 20.00 | 0.20 | 20.00 |
| Cream flavour | | | | |
| Natural and Artificial | 0.01 | 0.75 | 0.01 | 0.75 |
| Vanilla Custard flavour | | | | |
| Total | 100.00 | 10000.00 | 100.00 | 10000.00 |

For the ASSP X formula, the acid soluble soy protein ingredient is dissolved in water at 38° C. (100° F.) using moderate shear. After all lumps are dispersed (about 20 minutes), sodium hexametaphosphate is added and the slurry is mixed for 15 minutes further. The pH is adjusted to 7.5 with 1.0 N sodium hydroxide. Food grade antifoam is added if foam levels become problematic, and mixing continues for another 30 minutes.

The temperature is raised to 77° C. (170° F.). Mixing continues at low speed for 15 minutes. The pH is maintained between 7.2 and 7.5.

The slurry is then homogenized at 300 bar (4200 psi),

The appropriate amount of protein slurry is weighed out. and the dipotassium phosphate is added.

For the Supro® XF 8021 formula, the water and phosphate buffer are mixed and heated to 60° C. using a steam jacketed stainless steel process vessel equipped with an air operated propeller mixer. The protein is uniformly dispersed into the water/phosphate buffer mixture using moderate to high speed mixing, which is then heated to 77° C. and mixed at slow speed for 6 minutes to facilitate complete hydration.

To these protein/buffer slurries are added the carbohydrates and SSL and then mixing continues for 5 minutes. A preblend of the soybean oil and PS60 is then added to the slurry and mixing continues for an additional for 5 minutes to complete the ingredient addition. The slurries are homogenized using a 3 piston, 2 stage NIRO Model 2006 homogenizer at 2500 psi total (500 psi, 2^{nd} stage/2000 psi, 1^{st} stage. The slurries were UHT heat treated at 142° C. for 4 to 6 seconds and then cooled to 31° C. bottled into pre-sterilized 250 ml Nalgene bottles, capped and stored at 4° C.

### Example 5

### Neutral Dry Blended Beverage

TABLE 12
Weight-loss dry mix formula

| | | Batch size 500 g | |
|---|---|---|---|
| Ingredients: | g/serving | % | g/batch |
| ASSP X | 13 | 37.35 | 186.73 |
| Sodium hexametaphosphate | 1.16 | 3.33 | 16.66 |
| Sodium Carbonate | 0.09 | 0.26 | 1.29 |
| Whey Protein Isolate WPI | 6 | 17.24 | 86.18 |
| Sucrose | 6 | 17.24 | 86.18 |
| Digestion resistant maltodextrin | 4 | 11.49 | 57.45 |
| Fat Powder (65.5% Fat) | 2 | 5.75 | 28.73 |
| Xanthan gum | 0.2 | 0.57 | 2.87 |
| Stevia | 0.95 | 2.73 | 13.65 |
| Potassium Citrate | 0.4 | 1.15 | 5.75 |
| Vitamin Premix | 0.16 | 0.46 | 2.30 |
| Vanilla Flavour | 0.85 | 2.44 | 12.21 |
| Total: | 34.81 | 100.00 | 500.00 |

The ASSP was mixed with the sodium hexametaphosphate and the sodium carbonate and blended for 10 minutes

The rest of the ingredients were added to the mix and blended for a further 10 minutes.

The powder mix was packaged into individual sachets and heat sealed. Approximately 35 g of mixture was placed in each sachet.

The resulting product was stirred or shaken into 230 ml (8 fluid ounces) of water until smooth (several minutes) to replace a meal as part of a weight loss program

### Example 6

### Sports Nutrition Beverage

The following is an illustrative example and is not meant to limit the present invention in any way and the scope of the example would be apparent to those skilled in the art.

TABLE 13
Sports Nutrition Formula

| Ingredient | % |
|---|---|
| Sodium Hexametaphosphate | 7.72 |
| Sodium Carbonate | 0.60 |
| ASSP X (94.86%) | 86.50 |
| Guar HV (Guar, High Viscosity) | 0.05 |
| Vitamin and mineral premix | 0.09 |
| Defatted Cocoa Powder | 4.68 |
| Chocolate Flavour | 0.32 |
| Aspartame | 0.00 |
| Acesulfam-K | 0.03 |
| TOTAL | 100.00 |

The ASSP is added to a V-blender, together with the sodium hexametaphosphate and the sodium carbonate and blended for 10 minutes

The rest of the ingredients are added to the blender and the mix is blended for a further 10 minutes

The powder mix is discharged from the blender and packaged into 1 kg multi-layer cans and sealed.

The resulting product is stirred or shaken at a rate of about 50 g into 230 ml (8 fluid ounces) of water until smooth (several minutes) to serve as a protein supplement for athletes in training

### Example 7

### Nutritional Supplement Beverage

The following is an illustrative example and is not meant to limit the present invention in any way and the scope of the example would be apparent to those skilled in the art.

TABLE 14
Clinical nutrition beverage

| | | weight per |
|---|---|---|
| | | 10000 g |
| Ingredient | % | batch(g) |
| Deionised Water | 79.24 | 7924.00 |
| Sodium Caseinate | 1.35 | 135.00 |
| Calcium Caseinate | 1.35 | 135.00 |
| ASSP X (94.86%) | 2.70 | 270.00 |
| Sodium Hexametaphosphate | 0.24 | 24.00 |
| Sucrose | 7.00 | 700.00 |
| Corn syrup solids (25DE) | 4.50 | 450.00 |
| Soybean oil | 0.80 | 80.00 |
| Canola oil | 0.75 | 75.00 |
| Corn oil | 0.70 | 70.00 |
| Lecithin, deoiled | 0.12 | 12.00 |
| Tricalcium phosphate | 0.20 | 20.00 |
| Magnesium phosphate, dibasic | 0.21 | 21.00 |
| Sodium chloride | 0.10 | 10.00 |
| Mixed Carrageenans | 0.01 | 1.00 |
| Cellulose Gum | 0.50 | 50.00 |
| Vitamin Premix | 0.07 | 7.00 |
| Vanilla Flavour | 0.16 | 16.00 |
| Total | 100.00 | 10000.00 |

Add process water (20-25° C.) to a process tank. Disperse the protein into the water using medium shear

Add sodium hexametaphosphate and continue to mix (10 minutes)

Adjust slurry pH to 7.5, using 1N sodium hydroxide solution

Warm slightly to 25-30° C. and homogenise at 300 bar (4200 psi). Check

final pH and adjust to pH 7.3-7.4

Dry blend carrageenan and the cellulose gum with a portion of the sugar and add to the protein slurry. Heat the slurry to 60° C. (140° F.)

Dry blend the caseinates with the rest of the sugar and add to the process tank. Allow to hydrate for 10 mins.

The remaining carbohydrates and minerals are added to the process tank and mixed for 5 mins.

The oil and lecithin are mixed separately, heated to 60° C. (140° F.) the added to the process tank with 5 mins mixing.

The vitamin/mineral premix and flavor are added and mixed for 2 mins.

The pH is recorded and the % solids adjusted accordingly to fall into the range 7.2-7.4

The entire product is then homogenized in two stages using a piston-type homogenizer at 180/30 bar (2500/500 psi) and passed through a UHT process at 144° C. (292° F.) for 5 secs.

The beverage is collected in cans at 21° C.-32′C (70° F.-90° F.), leaving a ½″ headspace in the can. The product is then retorted at 121° C. (250° F.) for 7 mins.

### Example 8

### Powder Infant Formula

TABLE 15

| | Control Batch Supro ® 1751 LN IP | | | Experimental Batch ASSP X | | |
|---|---|---|---|---|---|---|
| Ingredient | % | 5 Kg batch | Units | % | 5 Kg batch | Units |
| Maltodextrin | 23.175 | 1158.75 | g | 23.175 | 1158.75 | g |
| Soybean oil | 3.15 | 157.5 | g | 3.15 | 157.5 | g |
| High Oleic Safflower oil | 4.419 | 220.95 | g | 4.419 | 220.95 | g |
| Coconut oil | 2.925 | 146.25 | g | 2.925 | 146.25 | g |
| Algal Oil (DHA) | 0.45 | 22.5 | g | 0.45 | 22.5 | g |
| Algal Oil (ARA) | 0.45 | 22.5 | g | 0.45 | 22.5 | g |
| ASSP X | 0 | 0 | g | 6.525 | 326.25 | g |
| Supro ® 1751 LN IP | 6.525 | 326.25 | g | 0 | 0 | g |
| Sodium hexametaphosphate | 0 | 0 | g | 0.581 | 29.05 | g |
| Tripotassium Citrate | 0.9 | 45 | g | 0.9 | 45 | g |
| Vit A palmitate | 0.000405 | 20.25 | mg | 0.000405 | 20.25 | mg |
| Vit D2 calciferol | 0.00045 | 22.5 | mg | 0.00045 | 22.5 | mg |
| dl-tocopherol acetate | 0.009 | 450 | mg | 0.009 | 450 | mg |
| Vitamin K | 0.000045 | 2.25 | mg | 0.000045 | 2.25 | mg |
| Thiamin HCl | 0.00045 | 22.5 | mg | 0.00045 | 22.5 | mg |
| Riboflavin | 0.0009 | 45 | mg | 0.0009 | 45 | mg |
| Vit B6 HCl | 0.0003375 | 16.875 | mg | 0.0003375 | 16.875 | mg |
| Vit B12 | 0.0000027 | 0.135 | mg | 0.0000027 | 0.135 | mg |
| Niacinamide | 0.2925 | 14.625 | g | 0.2925 | 14.625 | g |
| Folate | 0.00009 | 4.5 | mg | 0.00009 | 4.5 | mg |
| Ca Pantothenate | 0.0036 | 180 | mg | 0.0036 | 180 | mg |
| Biotin | 0.000018 | 0.9 | mg | 0.000018 | 0.9 | mg |
| Ascorbic acid | 0.135 | 6.75 | g | 0.135 | 6.75 | g |
| m-Inositol | 0.0675 | 3.375 | g | 0.0675 | 3.375 | g |
| Choline chloride | 0.09 | 4.5 | g | 0.09 | 4.5 | g |
| Calcium diphosphate | 0.675 | 33.75 | g | 0 | 0 | g |
| Manganese Sulphate•H2O | 0.045 | 2.25 | g | 0.045 | 2.25 | g |
| Calcium Carbonate | 0.225 | 11.25 | g | 0.722 | 36.1 | g |
| Sodium Chloride | 0.135 | 6.75 | g | 0 | 0 | g |
| Magnesium Chloride•6H2O | 0.225 | 11.25 | g | 0.225 | 11.25 | g |
| Potassium Iodide | 0.0225 | 1.125 | g | 0.0225 | 1.125 | g |
| Sodium selenate | 0.00225 | 0.1125 | mg | 0.00225 | 112.5 | mg |
| Taurine | 0.0225 | 1.125 | g | 0.0225 | 1.125 | g |
| L-carnitine | 0.0225 | 1.125 | g | 0.0225 | 1.125 | g |
| Iron II Sulphate•7H2O | 0.0045 | 0.225 | mg | 0.0045 | 225 | mg |
| Zinc Sulphate | 0.045 | 2.25 | g | 0.045 | 2.25 | g |
| Copper Sulphate | 0.0225 | 1.125 | g | 0.0225 | 1.125 | 9 |
| Water | 56.16 | 2808.07 | g | 56.16 | 2808.07 | g |
| Total | 100.00 | 5000 | g | 100.00 | 5000 | g |

### Process:

1. Mix Vit A palmitate, Vit D2 calciferol, dl-tocopherol acetate, Vitamin K, Thiamin HCl, Riboflavin, Vit B6 HCl, Vit B12, Niacinamide, Folate, Ca Pantothenate, Biotin, Ascorbic acid, m-Inositol, Choline chloride, Calcium diphosphate, Manganese Sulphate. H2O, Calcium Carbonate, Sodium Chloride, Magnesium Chloride.6H2O, Potassium Iodide, Sodium selenate, Taurine, L-carnitine, Iron II Sulphate.7H2O, Zinc Sulphate, and Copper Sulphate together to form a preblend

2. For the Control Batch, add cold (about 20° C.), deionized process water to a steam jacketed mixing tank of suitable size and add dipotassium citrate. Allow to dissolve.

3. Add Supro® to citrate solution with good, high-shear mixing and disperse well.

4. When the soy protein is well dispersed (absence of clumps), turn on the steam and begin heating. Allow the protein dispersion to reach 80° C., with constant high shear mixing.

5. Homogenise the protein dispersion at 200 bar (single stage).

6. For the ASSP batch, add the process water (20-25° C.) to a steam jacketed mixing vessel of suitable size. Disperse the protein into the water using medium shear

7. Add sodium hexametaphosphate and continue to mix (10 minutes)

8. Adjust slurry pH to 7.5, using 1N potassium hydroxide solution

Warm slightly to 25-30° C. and homogenise at 300 bar (4200 psi). Check final pH and adjust to pH 7.3-7.4.

9. For both batches, add the maltodextrin to the protein dispersion and dissolve.

10. Heat the coconut oil to above its melting point (typically about 25° C.) and add the other, liquid oils. Thaw and open the algal oils at the very last minute, weigh the appropriate quantity and add to the bulk oil. Add the oil mixture to the protein-maltodextrin slurry and mix using high shear mixing. Avoid the incorporation of air by adjusting the mixer head appropriately. If necessary, increase the temperature of the blend to >60° C. by opening the steam valve.

11. Homogenise in two stages at 200 and 30 bar.

12. Pump the homogenised blend to the spray dry and dry to about 3% moisture using about 185° C. inlet temperature and 85° C. outlet.

13. Cool and package the powder as rapidly as possible. Store in sealed containers under nitrogen.

14. When the powder is completely cool, rebulk the formula and add the vitamin premix at the appropriate rate. Mix thoroughly to ensure homogeneity.

15. Agglomerate using a Vector VFC-LAB3 Fluid Bed Freund-Vector made by the Vector Corporation, Marion, Iowa, rewetting with a 4% solution of a de-oiled lecithin (SOLEC®F., Solae, St. Louis, Mo.) fed at a rate of 40 g min⁻¹, and re-drying to <3% moisture at a temperature of 88° C.

16. Repackage in 350-500 g sealed containers flushed with nitrogen

### Example 9

### Liquid Infant Formula

The following example illustrates a liquid embodiment of the calcium fortified, soy-based, infant formulas of the present invention. The exemplified formula is described further in Table 16.

TABLE 16

| | | per 10000 g |
|---|---|---|
| Ingredient | % addition | batch (g) |
| Maltodextrin | 7.57565 | 757.565 |
| Soybean Oil | 1.0297 | 102.97 |
| HO Safflower | 1.444522 | 144.4522 |
| Coconut oil | 0.95615 | 95.615 |
| DHA algal oil | 0.148 | 14.8 |
| ARA algal oil | 0.148 | 14.8 |
| ASSP X | 2.13295 | 213.295 |
| Sodium hexametaphosphate | 0.19 | 19 |
| Vit A palmitate | 0.00013239 | 0.013239 |
| Vit D2 calciferol | 0.0001471 | 0.01471 |
| dl-tocopherol acetate | 0.002942 | 0.2942 |
| Vitamin K | 0.00001471 | 0.001471 |
| Thiamin HCl | 0.0001471 | 0.01471 |
| Riboflavin | 0.0002942 | 0.02942 |
| Vit B6 HCl | 0.000110325 | 0.0110325 |
| Vit B12 | 8.826E−07 | 0.00008826 |
| Niacinamide | 0.095615 | 9.5615 |
| Folate | 0.00002942 | 0.002942 |
| Ca Pantothenate | 0.0011768 | 0.11768 |
| Biotin | 0.000005884 | 0.0005884 |
| Ascorbic acid | 0.04413 | 4.413 |
| m-Inositol | 0.022065 | 2.2065 |
| Choline chloride | 0.02942 | 2.942 |
| Calcium diphosphate | 0.22065 | 22.065 |
| Manganese Sulphate•H2O | 0.01471 | 1.471 |
| Calcium Carbonate | 0.07355 | 7.355 |
| Tripotassium Citrate | 0.2942 | 29.42 |
| Sodium Chloride | 0.04413 | 4.413 |
| Magnesium Chloride•6H2O | 0.07355 | 7.355 |
| Potassium Iodide | 0.007355 | 0.7355 |
| Sodium selenate | 0.0007355 | 0.07355 |
| Taurine | 0.007355 | 0.7355 |
| L-carnitine | 0.007355 | 0.7355 |
| Iron II Sulphate•7H2O | 0.001471 | 0.1471 |
| Zinc Sulphate | 0.01471 | 1.471 |
| Copper Sulphate | 0.007355 | 0.7355 |
| Water | 85.41167069 | 8541.167069 |
| Totals | 100 | 10000 |

### Process:

1. Mix Vit A palmitate, Vit D2 calciferol, dl-tocopherol acetate, Vitamin K, Thiamin HCl, Riboflavin, Vit B6 HCl, Vit B12, Niacinamide, Folate, Ca Pantothenate, Biotin, Ascorbic acid, m-Inositol, Choline chloride, Calcium diphosphate, Manganese Sulphate, H2O, Calcium Carbonate, Sodium Chloride, Magnesium Chloride.6H2O, Potassium Iodide, Sodium selenate, Taurine, L-carnitine, Iron II Sulphate.7H2O, Zinc Sulphate, and Copper Sulphate together to form a preblend
2. Add the process water (20-25° C.) to a steam jacketed mixing vessel of suitable size. Disperse the protein into the water using medium shear
3. Add sodium hexametaphosphate and continue to mix (10 minutes)
4. Adjust slurry pH to 7.5, using 1N potassium hydroxide solution
Warm slightly to 25-30° C. and homogenise at 300 bar (4200 psi). Check final pH and adjust to pH 7.3-7.4.
   5. Add the maltodextrin to the protein dispersion and dissolve.
   6. Heat the coconut oil to above its melting point (typically about 25° C. and add the other, liquid oils. Thaw and open the algal oils at the very last minute, weigh the appropriate quantity and add to the bulk oil. Add the oil mixture to the protein-maltodextrin slurry and mix using high shear mixing. Avoid the incorporation of air by adjusting the mixer head appropriately. If necessary, increase the temperature of the blend to >60° C. by opening the steam valve.
   7. Homogenise in two stages at 200 and 30 bar.
   8. The homogeneous mixture is packaged into suitable, retortable containers and sterilized at 121° C. to reach an Fₒ value of about 4.

### Example 10

### B.O.T.H Beverage

### Experimental Example B.O.T.H Beverage

The following is an illustrative example and is not meant to limit the present invention in any way and the scope of the example would be apparent to those skilled in the art.

TABLE 17
B.O.T.H. Beverage

| | B.O.T.H. | B.O.T.H |
|---|---|---|
| INGREDIENTS | (%) | 1000 g |
| Water, Tap | 44.12 | 441.23 |
| Sodium Hexametaphosphate | 0.13 | 1.25 |
| ASSP X (94.86%) | 1.69 | 16.87 |
| Sugar | 1.75 | 17.50 |
| Maltodextrin, 15DE | 1.76 | 17.61 |
| Mixed Carageenans | 0.01 | 0.10 |
| Cellulose Gum | 0.01 | 0.05 |
| Vanilla flavor | 0.04 | 0.40 |
| Sunflower oil | 0.50 | 5.00 |
| 1% fat milk | 50.00 | 500.00 |
| Total | 100.00 | 1000.00 |

Tap water (441.23 g at 20-0.25° C.) was added to a container. The protein was dispersed in the water with medium shear

Sodium hexametaphosphate was added and mixing was continued for 10 minutes

The pH of the protein slurry was adjusted to 7.5, using 1N sodium hydroxide solution

The slurry was warmed slightly 25-30° C. and then homogenised at 300 bar (4200 psi). The pH was adjusted to 7.35

The Carrageenan and the cellulose gum was dry blended with a portion of the sugar and added to the protein slurry. The slurry was then heated to 80° C.

The rest of the sugar and the maltodextrin were then added to the process tank and mixed thoroughly until dispersed and dissolved.

The oil and the flavour were added to the batch and the mix was vigorously agitated to form a pre-emulsion

The batch was homogenised using a piston-type homogenizer in two stages at 180 bar (2500 psi) and 30 bar (500 psi)

The homogenized batch was cooled to ±5° C. before the 1% fat milk was weighed and added. Gentle mixing sufficed to render the blend homogeneous. The B.O.T.H product was tested for heat stability by slowly heating to 80° C. over a period of 30 minutes. The product was stable and no separation was observed.

### Example 11

### Experimental Example Flavoured Soy Beverages (Neutral pH) Chocolate

The following is an illustrative example and is not meant to limit the present invention in any way and the scope of the example would be apparent to those skilled in the art.

TABLE 18
Flavoured soy beverages (neutral pH) Chocolate

| | Chocolate | Chocolate |
|---|---|---|
| INGREDIENTS | (%) | g/10,000 g |
| Water, Tap | 82.98 | 8297.60 |
| Sodium Hexametaphosphate | 0.25 | 25.00 |
| ASSP X (94.86%) | 3.37 | 337.30 |
| Sugar | 8.00 | 800.00 |
| Maltodextrin, 15DE | 3.52 | 352.10 |
| kappa-carageenan | 0.02 | 2.00 |
| Cellulose Gum | 0.01 | 1.00 |
| Low fat cocoa powder (11% fat) | 0.80 | 80.00 |
| Vanilla flavour | 0.05 | 5.00 |
| Sunflower oil | 1.00 | 100.00 |
| Total | 100.00 | 10000.00 |

Add process water (20-25° C.) to a process tank. Disperse the protein into the water using medium shear

Add sodium hexametaphosphate and continue to mix (10 minutes)

Adjust slurry pH to 7.5, using 1N sodium hydroxide solution

Warm slightly to 25-30° C. and homogenize at 300 bar (4200 psi). Check final pH and adjust to pH 7.3-7.4

Dry blend carrageenan and the cellulose gum with a portion of the sugar and add to the protein slurry. Heat the slurry to 80° C.

Dry blend the cocoa powder with the rest of the sugar and add to the process tank. Mix thoroughly until dispersed and dissolved.

Add the oil and the flavour and mix well to form a pre-emulsion

Homogenize the batch using a piston-type homogenizer in two stages at 180 bar (2500 psi) and 30 bar (500 psi).

UHT process the batch, using indirect heating, at 145° C. for 7-9 seconds

Aseptically fill the product into aseptic containers

### Example 12

### Experimental Example Flavoured Soy Beverages (Neutral pH) Strawberry

The following is an illustrative example and is not meant to limit the present invention in any way and the scope of the example would be apparent to those skilled in the art.

TABLE 19
Flavoured soy beverages (neutral pH) Strawberry

| | Strawberry | Strawberry |
|---|---|---|
| INGREDIENTS | (%) | g/10,000 g |
| Water, Tap | 84.23 | 8422.60 |
| Sodium Hexametaphosphate | 0.25 | 25.00 |
| ASSP X (94.86%) | 3.37 | 337.30 |
| Sugar | 5.00 | 500.00 |
| Maltodextrin, 15DE | 3.52 | 352.10 |
| Mixed Carageenans | 0.02 | 2.00 |
| Cellulose Gum | 0.01 | 1.00 |
| Natural Colour | 1.30 | 130.00 |
| Strawberry flavour | 1.30 | 130.00 |
| Sunflower oil | 1.00 | 100.00 |
| Total | 100.00 | 10000.00 |

Add process water (20-25° C.) to a process tank. Disperse the protein into the water using medium shear

Add sodium hexametaphosphate and continue to mix (10 minutes)

Adjust slurry pH to 7.5, using 1N sodium hydroxide solution

Warm slightly to 25-30° C. and homogenise at 300 bar (4200 psi). Check final pH and adjust to pH 7.3-7.4

Dry blend carrageenan and the cellulose gum with a portion of the sugar and add to the protein slurry. Heat the slurry to 80° C.

Add the rest of the sugar and the maltodextrin to the process tank. Mix thoroughly until dispersed and dissolved.

Add the oil and the flavour and mix well to form a pre-emulsion

Homogenize the batch using a piston-type homogenizer in two stages at 180 bar (2500 psi) and 30 bar (500 psi).

UHT process the batch, using indirect heating, at 145° C. for 7-9 seconds

Aseptically fill the product into aseptic containers

### Example 13

### Experimental Example Flavoured Soy Beverages (Neutral pH) Vanilla

The following is an illustrative example and is not meant to limit the present invention in any way and the scope of the example would be apparent to those skilled in the art.

TABLE 20
Flavoured soy beverages (neutral pH) Vanilla

| | Vanilla | Vanilla g/ |
|---|---|---|
| INGREDIENTS | (%) | 10,000 g |
| Water, Tap | 88.25 | 8824.60 |
| Sodium Hexametaphosphate | 0.25 | 25.00 |
| ASSP X (94.88%) | 3.37 | 337.30 |
| Sugar | 3.50 | 350.00 |
| Maltodextrin, 15DE | 3.52 | 352.10 |
| Mixed Carageenans | 0.02 | 2.00 |
| Cellulose Gum | 0.01 | 1.00 |
| Vanilla flavour | 0.08 | 8.00 |
| Sunflower oil | 1.00 | 100.00 |
| Total | 100.00 | 10000.00 |

Add process water (20-25° C.) to a process tank. Disperse the protein into the water using medium shear

Add sodium hexametaphosphate and continue to mix (10 minutes).

Adjust slurry pH to 7.5, using 1N sodium hydroxide solution.

Warm slightly to 25-30° C. and homogenise at 300 bar (4200 psi). Check final pH and adjust to pH 7.3-7.4

Dry blend carrageenan and the cellulose gum with a portion of the sugar and add to the protein slurry. Heat the slurry to 80° C.

Add the rest of the sugar and the maltodextrin to the process tank. Mix thoroughly until dispersed and dissolved.

Add the oil and the flavour and mix well to form a pre-emulsion

Homogenise the batch using a piston-type homogenizer in two stages at 180 bar (2500 psi) and 30 bar (500 psi).

UHT process the batch, using indirect heating, at 145° C. for 7-9 seconds

Aseptically fill the product into aseptic containers.

### Example 14

### Experimental Example Flavoured Soy Beverages (Neutral pH) Coffee

The following is an illustrative example and is not meant to limit the present invention in any way and the scope of the example would be apparent to those skilled in the art.

TABLE 21
Flavoured soy beverages (neutral pH) Coffee

| | Coffee | Coffee g/ |
|---|---|---|
| INGREDIENTS | (%) | 10,000 g |
| Water, Tap | 84.33 | 8432.60 |
| Sodium Hexametaphosphate | 0.25 | 25.00 |
| ASSP X (94.86%) | 3.37 | 337.30 |
| Sugar | 5.00 | 500.00 |
| Maltodextrin, 15DE | 3.52 | 352.10 |
| Mixed Carageenans | 0.02 | 2.00 |
| Cellulose Gum | 0.01 | 1.00 |
| Coffee extract | 2.50 | 250.00 |
| Sunflower oil | 1.00 | 100.00 |
| Total | 100.00 | 10000.00 |

Add process water (20-25° C.) to a process tank. Disperse the protein into the water using medium shear

Add sodium hexametaphosphate and continue to mix (10 minutes)

Adjust slurry pH to 7.5, using 1N sodium hydroxide solution

Warm slightly to 25-30° C. and homogenise at 300 bar (4200 psi). Check final pH and adjust to pH 7.3-7.4

Dry blend carrageenan and the cellulose gum with a portion of the sugar and add to the protein slurry. Heat the slurry to 80° C.

Add the rest of the sugar and the maltodextrin to the process tank. Mix thoroughly until dispersed and dissolved. Add the coffee extract and dissolve

Add the oil and mix well to form a pre-emulsion

Homogenize the batch using a piston-type homogenizer in two stages at 180 bar (2500 psi) and 30 bar (500 psi).

UHT process the batch, using indirect heating, at 145° C. for 7-9 seconds

Aseptically fill the product into aseptic containers.

### Example 15

### Nutritional Supplement Beverage

The following is an illustrative example and is not meant to limit the present invention in any way and the scope of the example would be apparent to those skilled in the art.

TABLE 22
Nutritional Supplement Beverage

| | | weight per |
|---|---|---|
| | | 10000 g |
| Ingredient | % | batch(g) |
| Deionized Water | 79.48 | 7948.00 |
| Milk Protein Isolate | 1.35 | 135.00 |
| Whey Protein Isolate | 1.35 | 135.00 |
| ASSP X (94.86%) | 2.70 | 270.00 |
| Sucrose | 7.00 | 700.00 |
| Corn syrup solids (25DE) | 4.50 | 450.00 |
| Soybean oil | 0.80 | 80.00 |
| Canola oil | 0.75 | 75.00 |
| Corn oil | 0.70 | 70.00 |
| Lecithin, deoiled | 0.12 | 12.00 |
| Tricalcium phosphate | 0.20 | 20.00 |
| Magnesium phosphate, dibasic | 0.21 | 21.00 |
| Sodium chloride | 0.10 | 10.00 |
| Mixed Carrageenans | 0.01 | 1.00 |
| Cellulose Gum | 0.50 | 50.00 |
| Vitamin Premix | 0.07 | 7.00 |
| Vanilla Flavour | 0.16 | 16.00 |
| Total | 100.00 | 10000.00 |

Add process water (20-25° C.) to a process tank. Disperse the protein into the water using medium shear.

Add sodium hexametaphosphate and continue to mix (10 minutes).

Adjust slurry pH to 7.5, using 1N sodium hydroxide solution.

Warm slightly to 25-30° C. and homogenize at 300 bar (4200 psi). Check final pH and adjust to pH 7.3-7.4.

Dry blend carrageenan and the cellulose gum with a portion of the sugar and add to the protein slurry. Heat the slurry to 60° C. (140° F.).

Dry blend the whey protein isolate and the milk protein isolate with the rest of the sugar and add to the process tank. Allow to hydrate for 10 mins.

The remaining carbohydrates and minerals are added to the process tank and mixed for 5 mins.

The oil and lecithin are mixed separately, heated to 60° C. (140° F.) the added to the process tank with 5 mins mixing.

The vitamin/mineral premix and flavor are added and mixed for 2 minutes.

The pH is recorded and adjusted accordingly to fall into the range 7.2-7.4.

The entire product is then homogenized in two stages using a piston-type homogenizer at 180/30 bar (2500/500 psi) and passed through a UHT process at 144° C. (292° F.) for 5 secs.

The beverage is collected in cans at 21° C.-32° C. (70° F.-90° F.), leaving a ½″ headspace in the can. The product is then retorted at 121° C. (250° F.) for 7 mins.

### Example 16

### Protein Extrudates Containing the Neutralized Acid Soluble Soy Protein Composition

In this Example, the neutralized acid soluble isolated soy protein (ASISP) is used to prepare a soy protein extrudate. A soy protein extrudate having approximately 87 wt. % protein is prepared. The extrudate is produced by introducing the ingredients of the protein-containing feed mixture formulation into a mixing tank to combine the ingredients and form a protein feed pre-mix. The pre-mix is then transferred to a hopper, where the pre-mix is held for feeding via screw feeder to a pre-conditioner to form a conditioned feed mixture by injecting steam and water, as known by one skilled in the art. The conditioned feed mixture is then fed to an extruder a long with fluids as needed and known by one skilled in the art. The feed mixture is heated by mechanical energy generated by the rotation of the screws of the extruder to form a molten extrusion mass. The molten extrusion mass exits the extruder through an extrusion die. The feed mixture is described in Table 23.

TABLE 23

| | Formula |
|---|---|
| Neutralized ASISP (wt. %) | 99.4 |
| Dicalcium Phosphate or | 0.3 |
| Calcium Carbonate(wt. %) | |
| Soy Lecithin (wt. %) | 0.3 |

The ingredients of the feed mixture are mixed in an ingredient blender until uniformly distributed. The dry feed mixture is then conveyed to an extruder, such as a Wenger Magnum TX52 extruder and processed as describe above to make extrudates.

TABLE 24

| | | Soy Nuggets |
|---|---|---|
| Formulation Information | | |
| Extrusion Parameters | | Wenger TX-52 |
| Dry Formula Feed Rate | (kg/hr) | 50-80 |
| Cylinder Steam | (kg/hr) | 3.0-5.0 |
| Cylinder Water | (kg/hr) | 5.0-15.0 |
| Extruder Water | (kg/hr) | 10.0-20.0 |
| Extruder Screw Speed | RPM | 250-700 |
| Knife Speed | RPM | 2000-3000 |
| SME (Specific Mechanical | kwh/hr | 45-125 |
| Energy) | | |
| Down Spout Temperature | (° C.) | 40-65 |
| Zone #1 Temperature | (° C.) | 35-55 |
| Zone #2 temperature | (° C.) | 40-85 |
| Zone #3 Temperature | (° C.) | 100-120 |
| Zone #4 Temperature | (° C.) | 100-120 |
| Head Pressure | (PSI) | 300-850 |
| National Dryer Information | | |
| Temperature of the Dryer- | (° F.) | 240-310 |
| Zone 1 | | |
| Time in the Dryer | (min) | 10-20 |

### Example 17

### A Food Bar Containing the Soy Protein Material

In this Example, samples of high protein food bars comprising proteinaceous material and sugar syrups are produced.

The following is a list of ingredients and a process that can be used to make the neutralized acid soluble soy protein of the present invention:

| | |
|---|---|
| Acid soluble soy protein | 100%, as is |
| Sodium hexametaphosphate | 8.9% or |
| Sodium citrate | 12.5% |
| A suitable alkaline salt, such as sodium carbonate | as necessary to reach a |
| | neutral pH |

These ingredients are dry blended together or with other ingredients as needed, and used in the final formulation of the desired product.

To obtain the high protein food bars, a first mixture is produced in a Winkworth mixer (available from Winkworth Machinery, Ltd., Reading, England) mixing at a speed of 48 revolutions per minute (rpm) for one minute. The first mixture comprises: 593.17 grams neutralized acid soluble isolated soy protein, 32.4 grams rice syrup solids (available from Natural Products, Lathrop, Calif.), 76.4 grams cocoa powder (available from DeZaan, Milwaukee, Wis.), 10.5 grams vitamin & mineral premix (available from Fortitech®, Schenectady, N.Y.), and 1.6 grams salt.

In a separate container, a second mixture containing liquid sugar syrups and liquid flavoring agents is then heated to a temperature of 37.8° C. (100° F.) by microwaving on high power for about 45 seconds. The liquid sugar syrup consists of 710.0 grams of a 55:45 blend of 63 DE corn syrup (available from Roquette®, LESTREM Cedex, France) to high fructose corn syrup 55 (available from International Molasses Corp., Rochelle Park, N.J.) and 566.0 grams glycerin. The liquid flavoring agents consist of 4.1 grams Edlong® Chocolate flavor 610 (available from The Edlong® Corporation, Elk Grove Village, Ill.), 4.1 grams Edlong® Chocolate flavor 614 (available from The Edlong® Corporation, Elk Grove Village, Ill.), and 2.0 grams vanilla flavoring (available from Sethness Greenleaf, Inc., Chicago, Ill.). The heated second mixture is then mixed the first mixture in a Winkworth mixer at a speed of 48 rpm for three minutes and forty-five seconds. The resulting dough is then sheeted out onto a marble slab and bars are cut into pieces weighing from about 45 grams to about 55 grams (the bar pieces are 102 millimeters in length, 10 millimeters in height, and 35 millimeters wide).

While the invention has been explained in relation to exemplary embodiments, it is to be understood that various modifications thereof will become apparent to those skilled in the art upon reading the description. Thereof it is to be understood that the invention disclosed herein is intended to cover such modifications as fall within the scope of the appealed claims.

What is claimed is:

1. A composition having neutral pH comprising an acid soluble protein which remains soluble in a neutral pH.

2. The composition of claim 1, wherein the composition is a neutral beverage.

3. The composition of claim 1, wherein the acid soluble protein is selected from the group consisting of oilseeds, including soy and canola.

4. The composition of claim 2, wherein the acid soluble protein is selected from the group consisting of oilseeds, including soy and canola.

5. The composition of claim 3 wherein the acid soluble soy protein is selected from the group consisting of soy protein isolate, soy protein concentrate, soy flour, and combinations thereof.

6. The composition of claim 4 wherein the acid soluble soy protein is selected from the group consisting of soy protein isolate, soy protein concentrate, soy flour, and combinations thereof.

7. A soy milk having a whiteness equal to dairy milk.

8. A soy milk having a whiteness index in the range of between about 50 and about 65.

9. An acid soluble protein that remains soluble in a neutral pH.

10. An acid soluble protein that remains soluble in a pH range of between about 6.5 to about 8.5.

11. A method of using an acid soluble protein in neutral pH conditions so that the acid soluble protein remains soluble comprising the steps of:
a. Hydrating the acid soluble protein at its native pH at a temperature of between about 20° C. and about 80° C.;
b. Adding a chelating agent
c. Adding alkali to neutralize the acid soluble protein;
d. Homogenizing the mixture at between about 10 bar and about 1000 bar;
e. Adding hydrocolloids;
f. Heating to between about 30° C. and about 85° C.; and
g. Adding remaining ingredients to form the neutralized acid soluble protein.

12. The method of claim 11, further including the following steps:
a. A heat process;
b. Homogenizing at between about 200 bar and about 230 bar;
c. Packaging the product; and,
d. Chilling the product.

13. The composition of claim 1, wherein the composition is a food composition.

14. The food composition of claim 13 selected from the group consisting of extrudates, bars, and combinations thereof.
